(19) United States
(12) Patent Application Publication
(10) Pub. No.: US 2024/0251825 A1
(43) Pub. Date: Aug. 1, 2024

(54) APPARATUS, SYSTEMS, AND METHODS TO CARBONATE WATER OR A WATER-BASED LIQUID

(71) Applicants: JEFFREY HANSON ROBBINS, San Diego, CA (US); Ariel Nehemiah Tenenbaum, San Diego, CA (US); GRAEME ROBION HOSTE, DENVER, CO (US)

(72) Inventors: JEFFREY HANSON ROBBINS, San Diego, CA (US); Ariel Nehemiah Tenenbaum, San Diego, CA (US); GRAEME ROBION HOSTE, DENVER, CO (US)

(21) Appl. No.: 18/102,746

(22) Filed: Jan. 29, 2023

(51) Int. Cl. A23L 2/54; A23L 2/38; A23L 2/40; B65D 43/02; B65D 47/06; B65D 51/16; B65D 81/32

(52) U.S. Cl. CPC A23L 2/54; A23L 2/38; A23L 2/40; B65D 43/0225; B65D 47/065; B65D 51/1638; B65D 81/32; B65D 2251/20

(57) ABSTRACT

There is disclosed an apparatus and methods for carbonating water or a water-based liquid from an effervescent composition. The apparatus may include a lid coupled to a container wherein the ratio of a volume capacity of a receptacle for effervescent composition to a volume capacity of the container for water or water-based liquid is greater than 1:986. A delivery device is disclosed to deliver an amount of effervescent composition from the receptacle to the water or water-based liquid when the lid and container are coupled to form a seal, wherein the seal holds pressure when the water or water-based liquid is carbonated. The apparatus further includes a pressure release mechanism coupled to one of the container or lid to release pressure when the container and lid are sealed and when the pressure increases above a seal strength and before the apparatus containing carbonated water or water-based liquid is open, and a headspace between an inside portion of the lid and a height of the water or water-based liquid with a volume capacity for gas to provide sufficient pressure when sealed to force carbon dioxide gas into the water or water-based liquid contents as carbonic acid.

### BACKGROUND OF THE INVENTION

### 1. Field of the Invention

The present invention relates to carbonation and containers, and more particularly, an apparatus and systems to carbonate water or water-based liquid by delivering an effervescent composition and methods of the same.

### 2. Background

Carbonated beverages produce a pleasant cooling and tingling mouthfeel when consumed. They also produce bubbles that can carry the aroma of the contents to engage the sense of smell and enhance the taste. Carbonation is common in many beverages as it can enhance the flavor and overall consumption experience.

The amount of carbon dioxide gas that dissolves in water or water-based liquid is proportional to pressure. And if the pressure is suddenly reduced, such as when a container is opened, the gas quickly comes out of solution and forms bubbles that rise to the surface. When carbonated water or water-based liquid is consumed, water, carbon dioxide, and saliva enzymes react to produce small amounts of carbonic acid which causes a tingly sensation or mouthfeel. The carbonation bubbles, rate of bubbling, and size of bubbles are known to alter the perceived flavor of a beverage by releasing an aroma. Smaller bubbles are faster than larger bubbles to dissolve and produce carbonic acid.

When a carbonated container is opened, carbon dioxide bubbles are visible inside the water or water-based liquid initiating at nucleation sites. A nucleation site may form in a cavity such as a small cavity in a container wall, which pins and stabilizes the site. When the bubble becomes large enough, the bubble buoyancy detaches it from such cavity nucleation site, it starts to rise, and usually leaves behind a small cavity to repeat the cycle. This repetition accounts for the trail of bubbles commonly observed in open or unsealed carbonated beverages.

Streams of continuous carbon dioxide bubbles from nucleation sites induce convection that affects their production rate, motion, and size. Bubbles grow rapidly on container walls when increased convective motion is occurring and more convective motion results when bubbles are growing more rapidly, creating a feedback relationship. As the bubbles rise, their momentum sustains the convective motion until a substantial part of the dissolved CO2 is released from water or water-based liquid left open to ambient conditions.

The radius of a single bubble increases over time at a fairly constant rate until it hits the surface. An individual bubble, the shape of a mushroom, may start around 1 millimeter in width and grow, or implode, to 3 millimeters in width before reaching the surface. Bubbles that form lower in the container have more time to grow in size and therefore bubbles that form closer to the surface are smaller when they reach the surface. The carbon dioxide bubbles rise and eventually reach the surface where, depending on the size of the bubble and properties of the water or water-based liquid, the bubbles may burst or float. If the container is closed or sealed, the pressure rises in the headspace of the container.

If the container is closed, the amount of carbon dioxide and pressure rises in the headspace and CO2 may dissolved back into the water or water-based liquid as carbonic acid hence carbonating the water or water-based liquid. The chemical reaction for this process is: H2O+CO2 [symbol] H2CO3. The water or water-based liquid may become saturated or supersaturated at ambient pressure and contain more carbon dioxide in solution than the liquid is able to store at a lower atmospheric pressure. The term ambient pressure refers to the pressure of the surrounding air, gas or liquid in contact with the container at a specific location.

When a bubble reaches the surface and bursts, the bubble film is torn, rapidly retracts, and leaves behind a curved cavity at the water or water-based liquid surface. Surface tension tries to flatten the surface, and the shape quickly changes from convex to concave and produces an upward jet that breaks up in midair. The smaller the bubble, the faster the jet. Both the tearing film and the fragmentation of the jet lead to the formation of small aerosol droplets. Aerosols can influence the emission of aroma, which can affect the perception of flavor.

There are several types of containers that are commonly used for storing and serving carbonated beverages. Existing carbonation containers include glass bottles with metal caps, aluminum cans, plastic bottles with plastic caps, and kegs. Another existing carbonation container is a carbonator container. A carbonator container is a specialized container that is carbonated with pressurized gas using a home appliance such as a soda maker.

Commercially, carbonation involves using specialized equipment and pressurized gas to carbonate liquid in a container such as a glass bottle, aluminum can, plastic bottle or keg. The carbonation occurs during the manufacturing process. The container containing carbonated liquid is then shipped and further distributed to the end user.

There are a number of reasons an apparatus and systems to carbonate water or water-based liquid by delivering an effervescent composition would be advantageous and is needed.

An apparatus and systems to carbonate water or water-based liquid by delivering an effervescent composition would provide a convenient and cost-effective alternative to traditional carbonation methods. Carbonating beverages using pressurized gas, in both a commercial operation or with a home appliance, can be expensive, requires specialized equipment, and cannot be used on the go. Specialized equipment may include a carbonator, soda maker or a keg. In contrast, using an effervescent composition allows for carbonation without the need for specialized equipment, making it a more affordable and portable option. An apparatus to carbonate water or water-based liquid by delivering an effervescent composition be easily carried and is useable anywhere, making it a convenient choice for people on the go.

An apparatus to carbonate water or water-based liquid by delivering an effervescent composition would reduce costs and decrease waste. Traditional carbonation methods often involve the use of disposable containers or single-use plastic bottles, which contribute to the growing problem of plastic waste. In contrast, an effervescent composition can be used to carbonate beverages in a reusable container, reducing the amount of plastic and other waste generated.

An apparatus to carbonate water or water-based liquid by delivering an effervescent composition would allow for greater customization of carbonated beverages. With traditional carbonation methods, the level of carbonation is typically fixed and cannot be easily adjusted. In contrast, a apparatus that uses an effervescent composition would allow users to control the amount of carbonation in their beverages, allowing for a more personalized and customizable experience.

An apparatus to carbonate water or water-based liquid by delivering an effervescent composition would reduce costs and decrease carbon emissions. Traditional carbonation methods often require heavy single-use containers filled with primarily water to be shipped from place to place which produces significant carbon emissions and is expensive. An apparatus that uses an effervescent composition eliminates the need to ship water around. Water is readily available anywhere and can be added by the end user to the container at their location.

Thus, there is a need and it would be advantageous to have an apparatus and systems to carbonate water or water-based liquid by delivering an effervescent composition, as container carbonation is currently only available commercially or with an appliance.

### SUMMARY

In one aspect, there is disclosed an apparatus including a lid coupled to a container wherein the ratio of a volume capacity of a receptacle for effervescent composition to a volume capacity of the container for water or water-based liquid is greater than 1:986. The container may include nucleation sites that contribute to motion of water or water-based liquid while effervescing. The apparatus further includes a receptacle being one of coupled to the lid or the container and a delivery device to deliver an amount of effervescent composition from the receptacle to the water or water-based liquid when the lid and container are coupled to form a seal, wherein the seal holds pressure when the water or water-based liquid is carbonated. The apparatus further includes a pressure release mechanism coupled to one of the container or lid to release pressure when the container and lid are sealed and when the pressure increases above a seal strength and before the apparatus containing carbonated water or water-based liquid is open, and a headspace between an inside portion of the lid and a height of the water or water-based liquid with a volume capacity for gas to provide sufficient pressure when sealed to force carbon dioxide gas into the water or water-based liquid contents as carbonic acid. The apparatus may be BPA free, food-grade, and toxin-free.

In another aspect, a method for carbonating water or water-based liquid is disclosed that includes delivering an amount of effervescent composition from a receptacle to a water or water-based liquid when a lid and container are coupled to form a seal, wherein the seal holds pressure inside the apparatus when the water or water-based liquid is carbonated and wherein the ratio of a volume capacity of the receptacle for effervescent composition to a volume capacity of the container for water or water-based liquid is greater than 1:986 and wherein the container includes nucleation sites that contribute to motion of water or water-based liquid while effervescing. The method further includes releasing pressure via a pressure release mechanism when the container and lid are sealed and when the pressure increases above a seal strength and before the apparatus containing carbonated water or water-based liquid is open, and providing a headspace between an inside portion of the lid and a height of the water or water-based liquid with a volume capacity for gas to provide sufficient pressure when sealed to force carbon dioxide gas into the water or water-based liquid contents as carbonic acid.

The effervescent composition may include an acid and at least one selected from the group of a carbonate, bicarbonate, and combinations thereof that produce carbon dioxide gas when mixed with water or water-based liquid. The lid may be coupled to one of a reusable container and a single-use container. The container may include one of a wall structure and a material to retain a low temperature of water or water-based liquid.

The seal may be one of an airtight gasket and a hermetic gasket. The pressure release mechanism may be one of automatic and manual. The container or lid may include markings for instructions of use. The apparatus may include a fill to line for water or water-based ingredients or a drink delivery device. The drink delivery device may be a spout, straw, opening, lip.

These and other objects of the present invention will become obvious to one skilled in the art following the detailed descriptions and specific examples below. While the examples and descriptions below generally describe the apparatus and represent preferred embodiments of the present invention, numerous variations and refinements are possible and such variations are included in the spirit of this invention.

### BRIEF DESCRIPTION OF THE FIGURES

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 illustrates a cross section view of an ACWEC with effervescent composition in the headspace.

FIG. 2 illustrates a cross section view of an ACWEC with effervescent composition reacting in the water or water-based liquid to carbonate the closed container.

FIG. 3 illustrates a cross section view of an ACWEC with an open, carbonated container bubbling.

FIG. 4 illustrates a perspective view of an embodiment of the ACWEC.

FIG. 5 illustrates a perspective view of the lid of FIG. 4 with effervescent composition.

FIG. 6 illustrates a perspective view of the lid of FIG. 4 without effervescent composition.

FIG. 7 illustrates a cross section view of an embodiment of an ACWEC.

FIG. 8 illustrates a perspective view of the ACWEC of FIG. 7 with straw closed.

FIG. 9 illustrates a perspective view of the ACWEC of FIG. 7 with straw open.

FIG. 10 illustrates a perspective view of the lid of FIG. 7.

FIG. 11 illustrates a perspective cross section view of the lid of FIG. 7.

FIG. 12 illustrates a perspective view of an embodiment of the ACWEC.

FIG. 13 illustrates a perspective view of the lid of FIG. 12.

FIG. 14 illustrates a perspective view looking up from the bottom of the lid of FIG. 12.

FIG. 15 illustrates a perspective cross section view of the receptacle for effervescent composition of FIG. 12.

FIG. 16 illustrates a cross section view of the ACWEC of FIG. 12.

FIG. 17 illustrates a cross section view of the lid of FIG. 12 with effervescent composition in the receptacle.

FIG. 18 illustrates a cross section view of the lid of FIG. 12 with effervescent composition leaving the receptacle.

FIG. 19 illustrates a cross section view of the lid of FIG. 12 with effervescent composition released from the receptacle.

FIG. 20 illustrates a perspective view of an embodiment of the ACWEC.

FIG. 21 illustrates a perspective view of an embodiment of the ACWEC.

FIG. 22 illustrates a top plan view of the ACWEC of FIG. 21.

FIG. 23 illustrates a top plan view of the ACWEC of FIG. 21 with effervescent composition.

FIG. 24 illustrates a top plan view of the ACWEC of FIG. 21 with effervescent composition being released from the receptacle.

FIG. 25 illustrates a perspective view looking up at the bottom of the lid of FIG. 21.

FIG. 26 Illustrates a cross section view of the ACWEC of FIG. 21.

FIG. 27 Illustrates a perspective view of an embodiment of the ACWEC.

FIG. 28 illustrates a perspective view looking down at the top of the lid of FIG. 27.

FIG. 29 illustrates a cross section view of the lid of FIG. 27.

FIG. 30 illustrates a perspective view of an embodiment of the ACWEC.

FIG. 31 illustrates a perspective cross section view of the lid of FIG. 30.

FIG. 32 illustrates a cross section view of the lid of FIG. 30 with effervescent composition and cap open.

FIG. 33 illustrates a cross section view of the lid of FIG. 30 with effervescent composition and cap closed and unthreaded.

FIG. 34 illustrates a cross section view of the lid of FIG. 30 with effervescent composition and cap closed and threaded, releasing effervescent composition.

FIG. 35 illustrates a perspective view of an embodiment of the ACWEC.

FIG. 36 illustrates a cross section view of the ACWEC of FIG. 35 with flip lid open with effervescent composition.

FIG. 37 illustrates a cross section view of the ACWEC of FIG. 35 with flip lid closed releasing effervescent composition.

FIG. 38 illustrates a perspective view of the lid of FIG. 40.

FIG. 39 illustrates a perspective view of the container of FIG. 40.

FIG. 40 illustrates a perspective view of an embodiment of the ACWEC.

FIG. 41 illustrates a cross section of the ACWEC of FIG. 40 with effervescent composition.

FIG. 42 illustrates a cross section of the ACWEC of FIG. 40 with the effervescent composition being released.

FIG. 43 shows a method for carbonating water or water-based liquid by delivering an effervescent composition by an apparatus and the systems thereof.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

In addition, each of the drawings is a schematic diagram and thus is not necessarily strictly illustrated. In each of the drawings, substantially the same structural components are assigned with the same reference signs, and redundant descriptions will be omitted or simplified.

### DETAILED DESCRIPTION

Each of the additional features and teachings disclosed below can be utilized separately or in conjunction with other features and teachings to provide an apparatus and systems to carbonate water or water-based liquid by delivering an effervescent composition (ACWEC) and methods of the same. Representative examples of the present invention, which utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense and are instead taught merely to particularly describe representative examples of the present teachings.

Moreover, the various features of the representative examples and the dependent claims may be combined in ways that are not specifically and explicitly enumerated to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for original disclosure, as well as for the purpose of restricting the claimed subject matter.

It is expressly understood that the words “degassing”, “outgassing”, “bubbling”, and “effervescing” each expressly mean the release of carbon dioxide gas from water or water-based liquid.

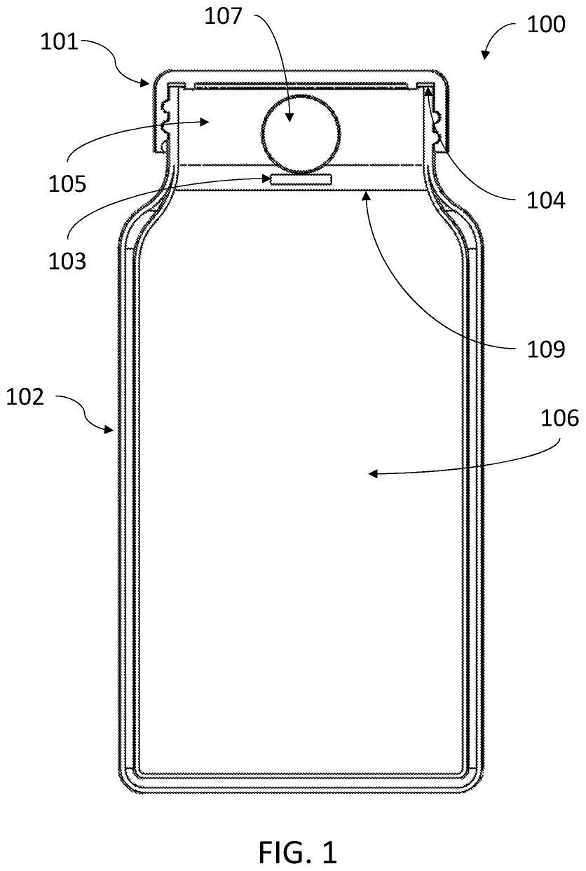

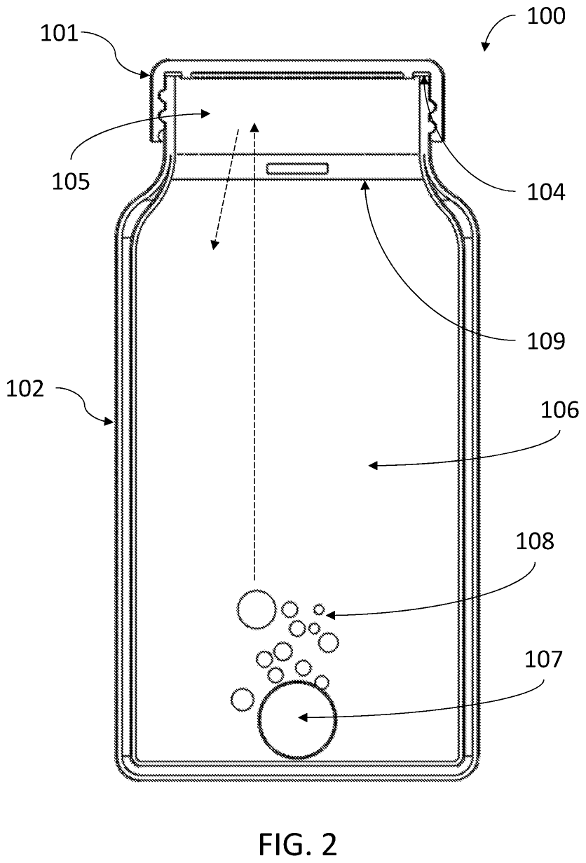

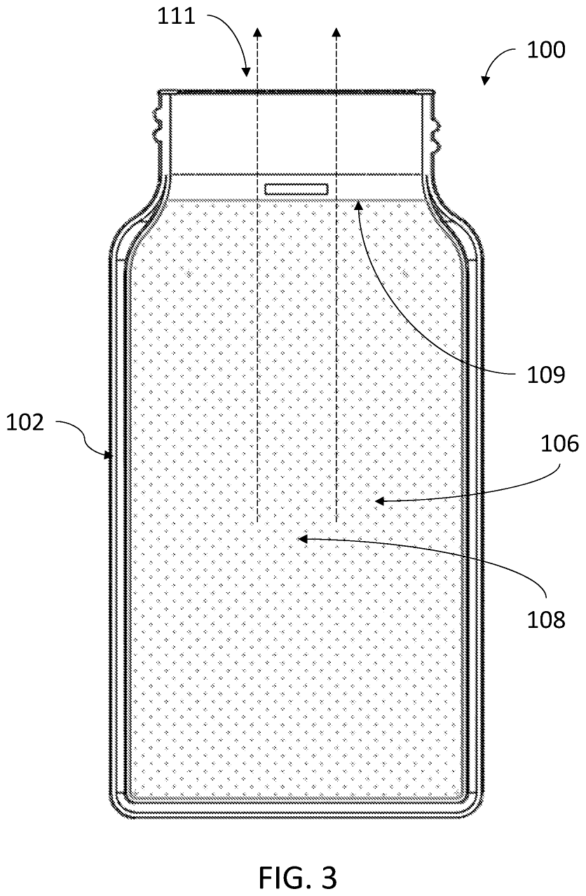

Referring to FIGS. 1-3, an embodiment of an apparatus and systems to carbonate water or water-based liquid by delivering an effervescent composition ACWEC 100 is illustrated according to certain aspects of the disclosure. In an aspect, the ACWEC 100 may comprise a lid 101. In another aspect, the ACWEC may comprise a container 102. The lid 101 or container 102 may comprise a receptacle for an effervescent composition 103. In an aspect, the ACWEC 100 may comprise a seal 104. In an embodiment, the seal 104 may comprise a pressure release mechanism such as a gasket. In yet another aspect, the ACWEC 100 contains a volume capacity for headspace 105. In an embodiment, the receptacle for effervescent composition 103 may be located in the headspace 105. In an aspect the ACWEC 100 contains a volume capacity for water or water-based liquid 106. FIG. 1 depicts an effervescent composition 107 and a water line 109. FIG. 1 depicts the volume capacity for water or water-based liquid 106 containing water or a water-based liquid. In an aspect, FIG. 2 depicts effervescence 108 from an effervescent composition 107 submerged in water or water-based liquid. When an effervescent composition contacts water or water-based liquid, a chemical reaction occurs, producing effervescence 108, as carbon dioxide gas. The effervescence 108, as carbon dioxide gas, in a closed or sealed 104 ACWEC 100, rises to the water line 109, enters the headspace 105, and then dissolves back into the water or water-based liquid as carbonic acid. The water or water-based liquid of the ACWEC in FIG. 2 is being carbonated. In an aspect, FIG. 3 depicts a carbonated and open 111 ACWEC 100. Effervescence 108, as carbon dioxide gas, forms bubbles in the water or water-based liquid and rises to the water line 109 and then departs the open 111 container 102. The effervescence 108 may form at nucleation sites, affect motion of water or water-based liquid, and other bubble characteristics and the affects thereof.

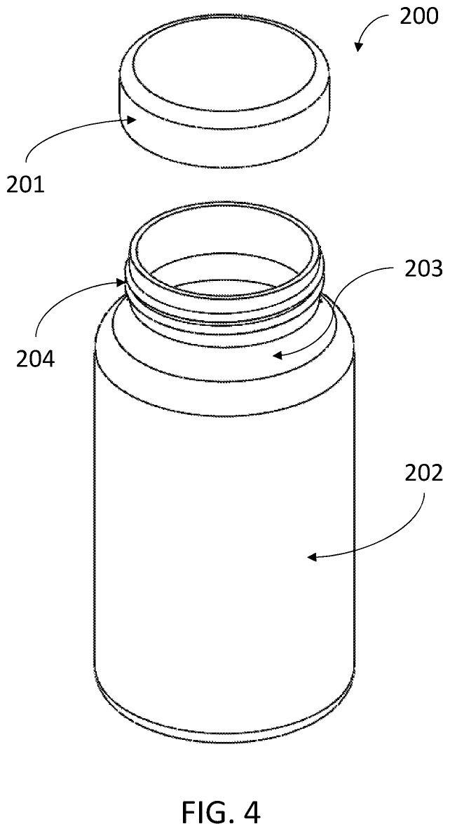

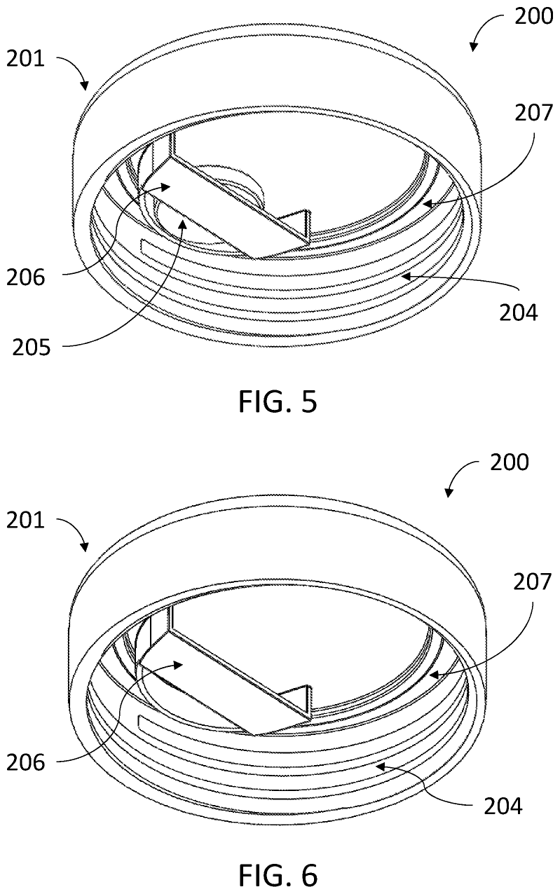

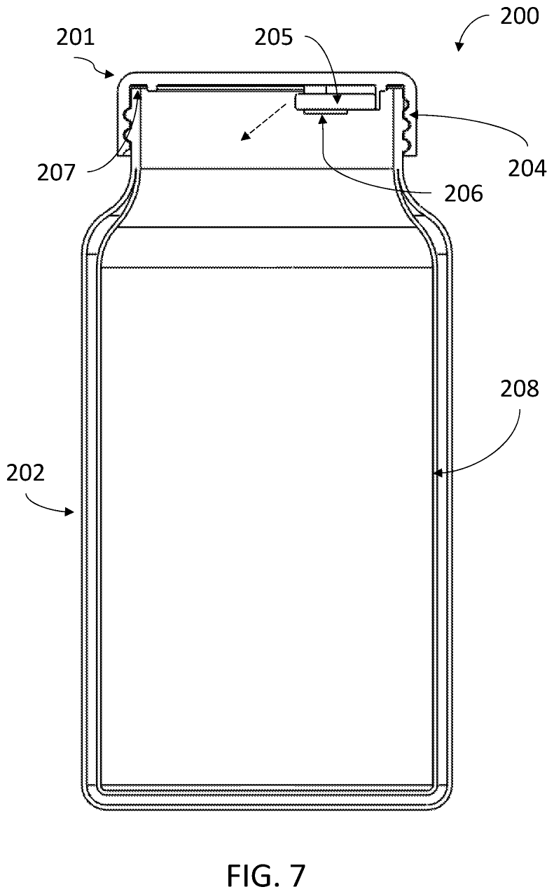

Referring to FIGS. 4-7, an embodiment of an apparatus and systems to carbonate water or water-based liquid by delivering an effervescent composition ACWEC 200 is illustrated according to certain aspects of the disclosure. In an aspect, the ACWEC 200 may comprise a lid 201. In another aspect, the ACWEC may comprise a container 202. The ACWEC 200 in FIG. 4 is depicted open with the lid 201 separate from the container 202. In an aspect, the ACWEC 200 may comprise threads 204 and curvature 203 in the contain 202 design and shape. In an aspect, FIG. 5 depicts a lid 200 with a receptacle for an effervescent composition 206 and an effervescent composition 205. In an embodiment, the receptacle for an effervescent composition may be a shelf. In an embodiment the shelf may be located on the interior side of the lid 201. In an embodiment, the shelf be angled up, down, or contain curvature which may hold effervescent composition 205 in place when putting the lid 201 on the container 202. In an embodiment, the shelf may contain a surface texture. In an embodiment, the shelf may be integral or removable. In an embodiment, there is flexibility on the volume capacity of the receptacle for an effervescent composition. In an embodiment, the shelf may be another type of receptacle for an effervescent composition. In an aspect, the lid 201 containing the effervescent composition 205 is put on the container 202 and a seal 207 is created utilizing a gasket. In an embodiment a seal 207 is created with a gasket by tightening lid 201 onto the container 202. The lid or container may contain a recess for a seal 207 or gasket. In an aspect, a container wall 208 is depicted. In an aspect, there is a mechanism or action to release the effervescent composition 205 from the receptacle for an effervescent composition 206. In an embodiment, the ACWEC 200 is tipped to release the effervescent composition into the water or water-based liquid. In an embodiment, the receptacle for an effervescent composition may contain threads 204. The threads may be internal or external threads. In an embodiment, the container wall 208 may be a double-wall, vacuum-insulated, or a single wall. In an embodiment, the wall 208, sidewall, or any upper, lower, or middle location of an interior surface, wall, floor, or ceiling may contain bubble nucleation sites that affect motion of water or water-based liquid while effervescing. In an embodiment, the container 202 may be plastic, glass, or metal. In an embodiment, the container 202 may comprise stainless steel. In an embodiment, the lid 201 may be compatible with a mason jar or reusable water bottle. In an embodiment, the lid 201 may be adapted, upsized, or downsized for use with a disposable bottle such as a wide mouth sports drink bottle or a narrow-mouth soft drink bottle. In an embodiment, the lid 201 may comprise markings to provide instruction for use, such as direction to tip the ACWEC 200 to release the effervescent composition into the water or water-based liquid.

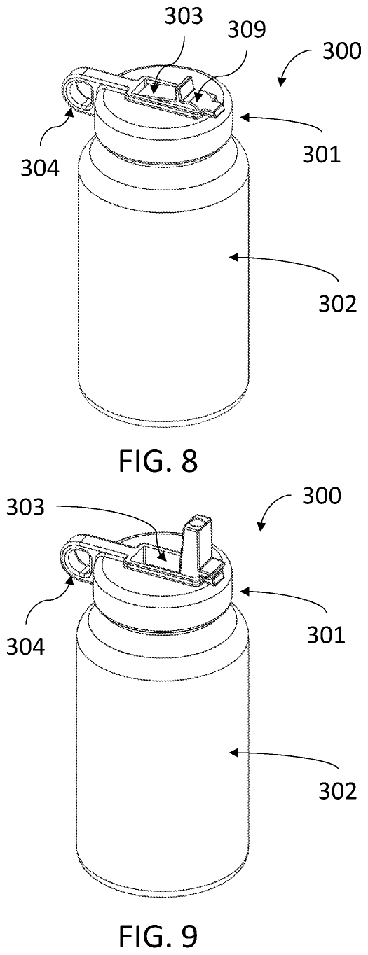

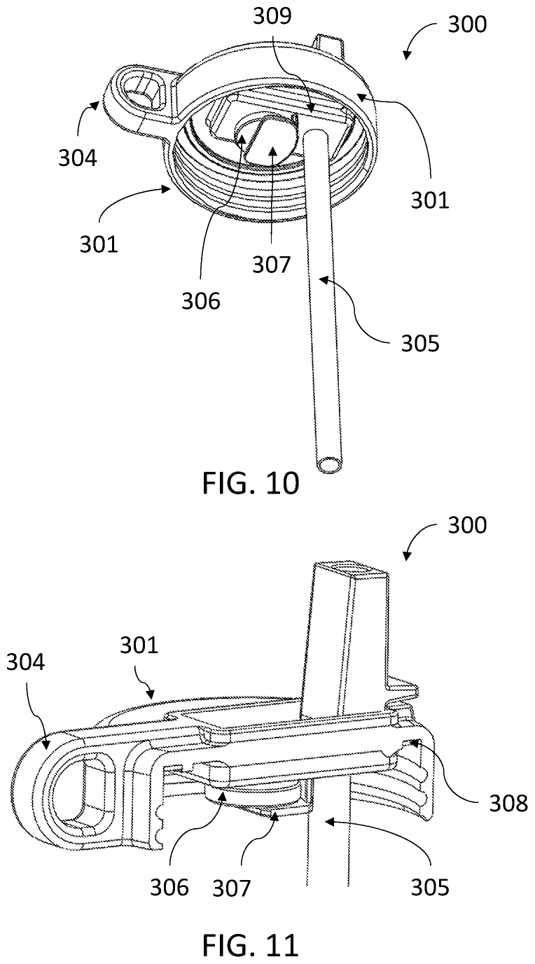

Referring to FIGS. 8-11, an embodiment of an apparatus and systems to carbonate water or water-based liquid by delivering an effervescent composition ACWEC 300 is illustrated according to certain aspects of the disclosure. In an aspect, the ACWEC 300 may comprise a lid 301. In another aspect, the ACWEC 300 may comprise a container 302. FIGS. 8-11 in an aspect, may comprise a straw lid or drink delivery device 303, an integral handle 304, a straw 305, an effervescent composition 306, a receptacle for effervescent composition 307, a seal 308, and a second internal seal 309. In an embodiment, the ACWEC 300 requires a mechanism or action to release effervescent composition from receptacle.

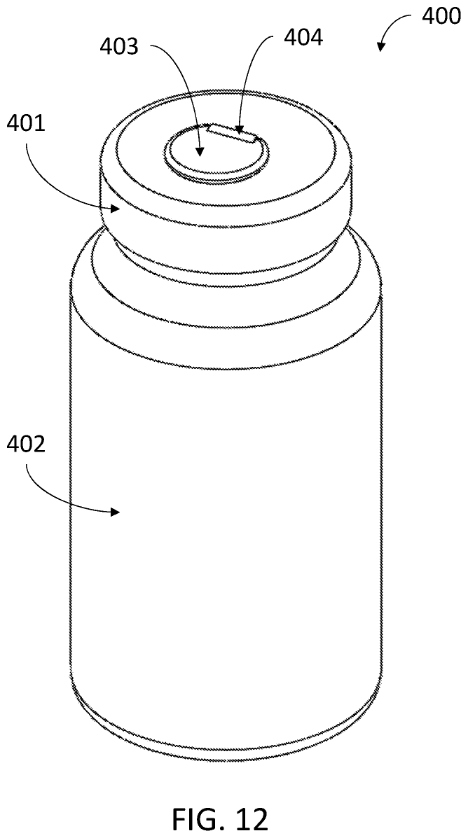

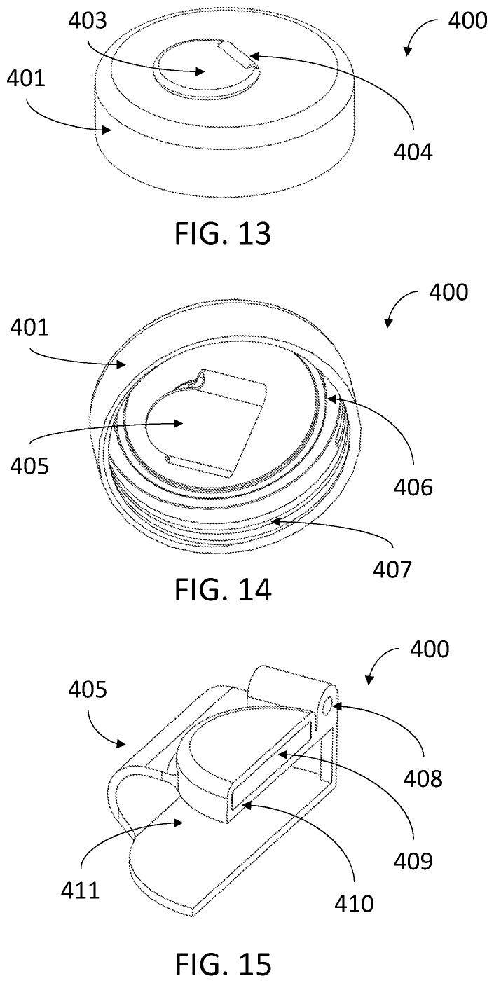

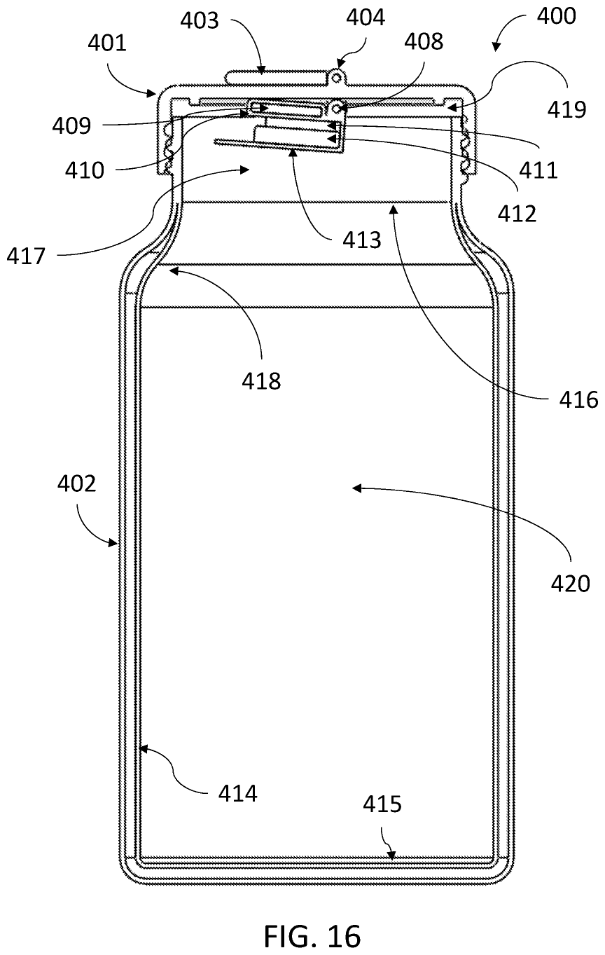

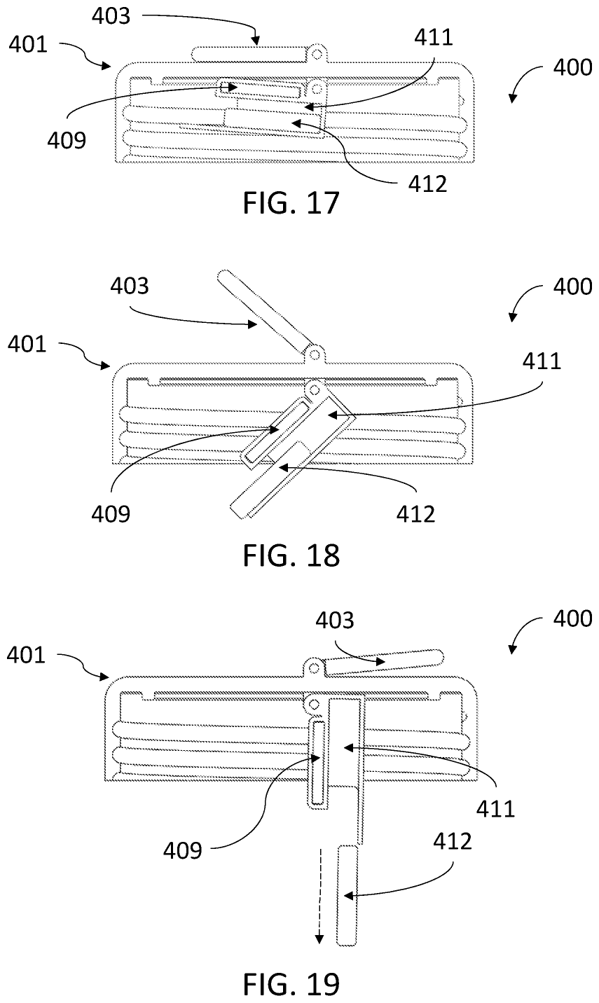

Referring to FIGS. 12-19, an embodiment of an apparatus and systems to carbonate water or water-based liquid by delivering an effervescent composition ACWEC 400 is illustrated according to certain aspects of the disclosure. In an aspect, the ACWEC 400 may comprise a lid 401. In another aspect, the ACWEC 400 may comprise a container 402. In an aspect, after being loaded with an effervescent composition 412 the lid 401 may be put on the container 402 thus closing the opening. FIGS. 12-19 in an aspect, may comprise a magnet 403 or magnetic material. In an embodiment ACWEC 400 may comprise a hinge 404. In an embodiment, a magnet may be lifted from the lid 401 surface. The hinge 404 may swing the magnet 403 over. In an embodiment, the underside of the lid 401 may comprise a receptacle for effervescent composition and a delivery device 405. In an embodiment, the lid 401 may attach to a container 402. In an embodiment the lid 401 and container 402 may contain threads 407 or other closure type and a seal 406. In an aspect, the delivery device 405 may contain a second magnet 409 or magnetic material. Any metal or magnet 403 409 may comprise an integral polymer 410 or coating such as plastic, rubber or silicone. In an embodiment, the delivery device 405 may contain a second hinge 408 to allow the delivery device 405 to drop or release the effervescent composition 412. The ACWEC 400 may comprise a mechanism or action to release the effervescent composition from the receptacle such as flipping over the magnet 403 on the exterior side of the lid 401. In an embodiment, the delivery device 405 with receptacle for effervescent composition may contain a volume capacity 411 that may be loaded with an effervescent composition 412. In an embodiment, the delivery device 405 may release or deliver the effervescent composition 412 into the water or water-based liquid. In an embodiment, any component 413 of the receptacle for effervescent composition or delivery device 405 may be composted of metal, plastic, rubber, silicon, polymer, or other BPA free, food-grade, non-toxic material. In an embodiment, the interior wall may contain nucleation sites 414 that affect motion of water or water-based liquid while effervescing. In another embodiment, the floor 415 or curvature 418 may contain bubble nucleation sites that affect motion of water or water-based liquid while effervescing. In yet another embodiment, other characteristics of the container 402 may contain bubble nucleation sites or affect motion of water or water-based liquid while effervescing. In an aspect, the water line 416 separates the headspace 417 from the volume capacity for water or water-based liquid 420. In an aspect the lid 401 may contain a seal 419 or gasket. In an embodiment, the seal 419 has sufficient strength to hold pressure produced from reaction of effervescent composition 412 with water and water-based liquid. In yet another aspect, the lid 401 may contain threads 407 that can function to relieve pressure from the ACWEC 400 before the lid 401 is completely removed. In another embodiment, the lid 401 or container 402 may comprise a pressure release valve. In an aspect, the pressure release valve may release if pressure increases above the strength of the seal 419. In an embodiment, the release of pressure may be a safety feature to prevent the lid or a cap from blowing off or popping off with significant force. FIGS. 17-19, illustrate an embodiment of the mechanism or action to release effervescent composition 412 from the receptacle. In a separate embodiment, the magnet 403 or magnetic material may not be lifted, it may slide, pivot, or otherwise change in position. In an embodiment, the receptacle for effervescent composition may take other action than swinging downward on a hinge 408 to release the effervescent composition 412. In an embodiment, the receptacle for effervescent composition, delivery device 405, or the lid 401 may comprise a spring, torsion spring, or other device to push the receptacle or delivery device 405 open once the magnet 403 is lifted. In yet another aspect, the magnet 403 may be held at 90 degrees or may flip to 180 degrees. In an aspect the magnet 403 may have instructions markings on it to indicate direction to flip in order to activate the release of the effervescent composition 412 into the water or water-based liquid. In an embodiment, the receptacle for effervescent composition with delivery device 405 must have capacity to hold an amount of effervescent composition 412 sufficient to carbonate water or water-based liquid in the amount of the container volume capacity for water or water-based liquid 420. In another embodiment, the ratio of the volume capacity of the receptacle for effervescent composition 411 to the container volume capacity of the water or water-based liquid 420 must be greater than 1:986. In an embodiment, the ACWEC 400 may contain a drinking opening, drink delivery device, or spout.

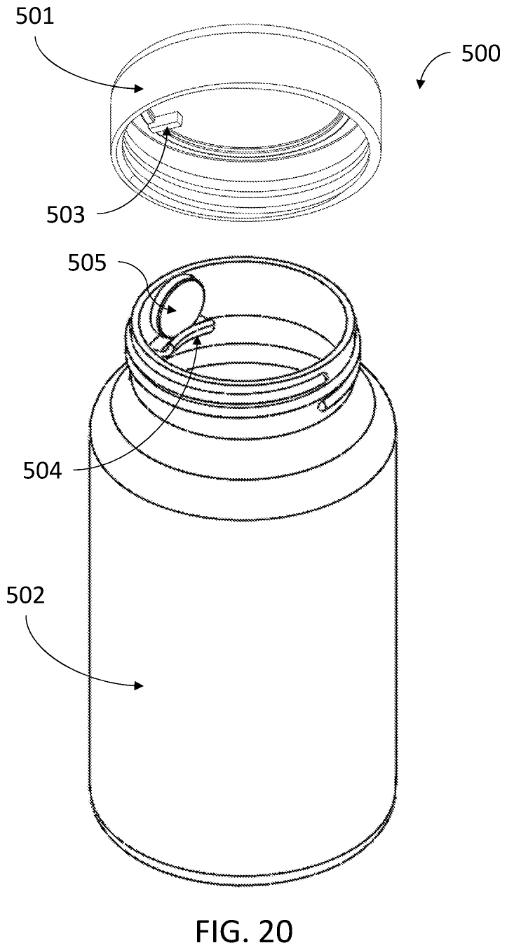

Referring to FIG. 20, an embodiment of an apparatus and systems to carbonate water or water-based liquid by delivering an effervescent composition ACWEC 500 is illustrated according to certain aspects of the disclosure. In an aspect, the ACWEC 500 may comprise a lid 501. In another aspect, the ACWEC 500 may comprise a container 502. In an aspect, the container 502 comprises the receptacle for effervescent composition 504. In an embodiment, the effervescent composition 505 is placed onto a receptacle for effervescent composition 504. In an aspect the ACWEC 500 contains female threads on the lid 501 and male threads on the container 502. In other embodiments, the lid 501 may be put on to the container with a mechanism other than threads, thus closing the opening. In an embodiment, the mechanism or action to release the effervescent composition from the receptacle 504 may be a protrusion 503 on the underside of the lid 501 that makes contact with the effervescent composition 505 and pushes it off the receptacle 504 and into water or water-based liquid. In an embodiment, the protrusion 503 makes contact with the effervescent composition 505, when the threaded lid 501 is tightened onto the container 502. In another embodiment, the receptacle for effervescent composition 504 may hold the effervescent composition 505 in vertical or flat position. An embodiment, that allows the effervescent composition 505 to be in a flat position may allow for more variation in volume capacity of the receptacle for effervescent composition. In an embodiment, the receptacle for effervescent composition 504 may be angled, angled more than once, curved, contain an incline, contain a decline, contain both an include and decline, or be another shape. In an embodiment, the protrusion 503, or kicker, may be located lower on the lid 501 as to make contact with the effervescent composition 504 in the center as opposed to the top. In yet another embodiment not shown, the protrusion 503, or kicker, may be located on the container 502 and the receptacle for effervescent composition 504 and effervescent composition 505 may be located on the lid 501. In another embodiment, there may be a separate removable component aside from the lid 501 and container 502 that comprises the receptacle for effervescent composition 504 and a mechanism or action to release the effervescent composition from the receptacle that may be inserted between the container 502 and the lid 501. In an embodiment, where there is a separate, removable, and size appropriate component comprising the receptacle for effervescent composition 504 and a mechanism or action to release the effervescent composition, any container 502 with matching lid 501 may be used.

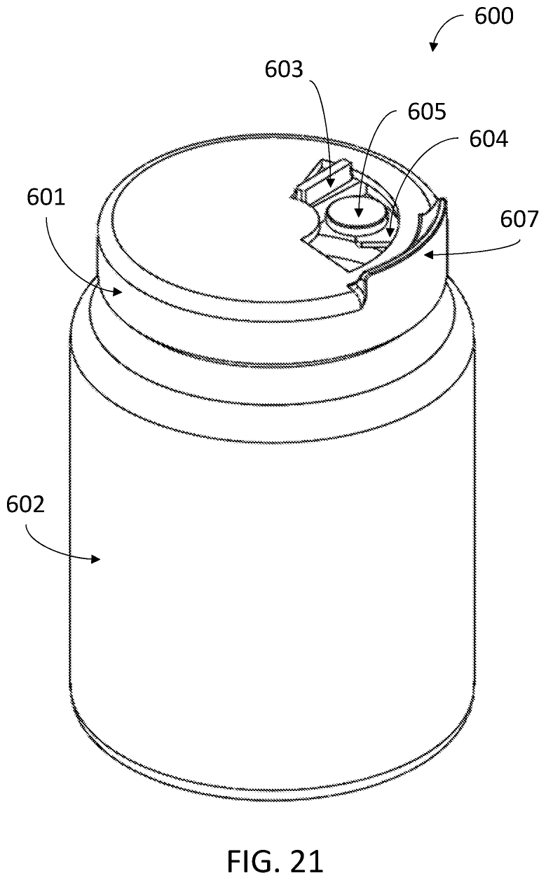

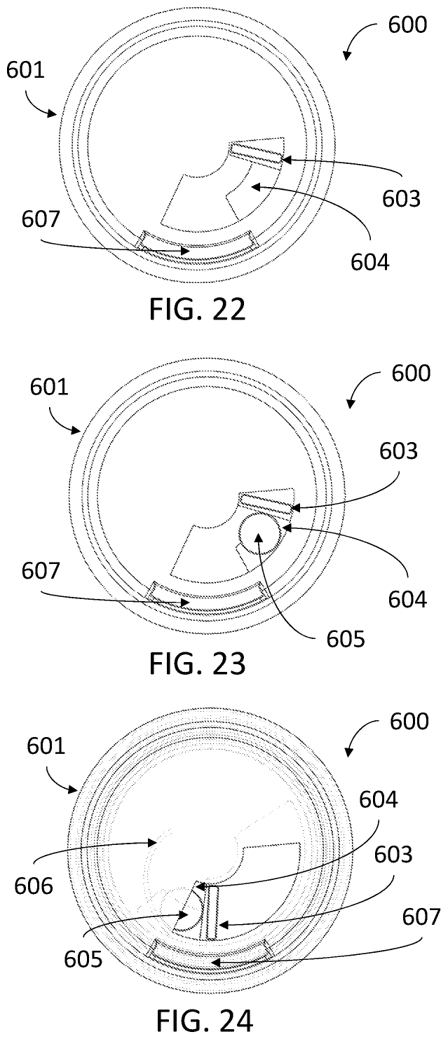

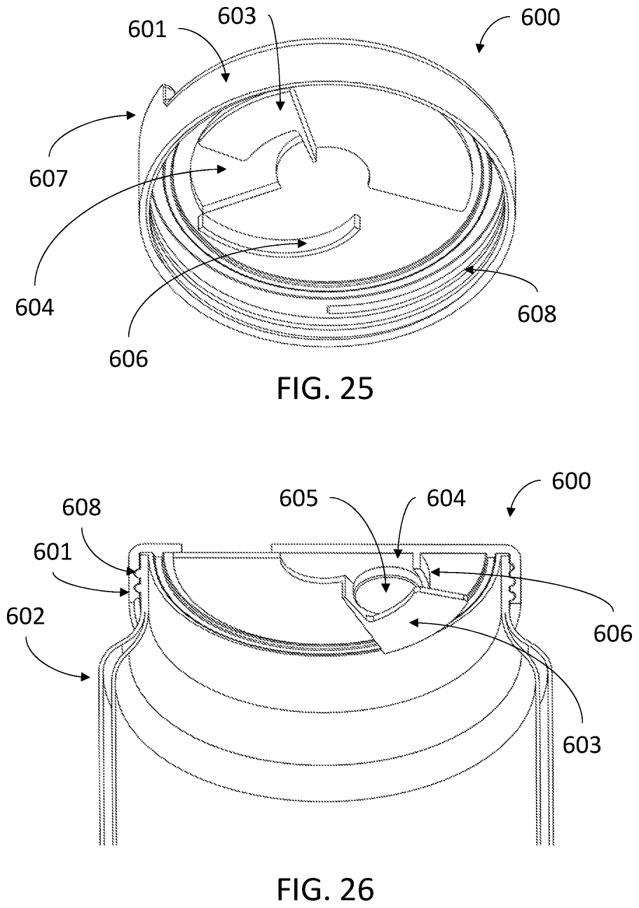

Referring to FIG. 21-26, an embodiment of an apparatus and systems to carbonate water or water-based liquid by delivering an effervescent composition ACWEC 600 is illustrated according to certain aspects of the disclosure. In an aspect, the ACWEC 600 may comprise a lid 601. In another aspect, the ACWEC 600 may comprise a container 602. In one embodiment, the lid 601 may attach to the container 602 with threads 608. In an aspect, the lid 601 may comprise the receptacle for effervescent composition 604. In another aspect, the lid 601 may comprise a sliding cover 603. In yet another aspect, the lid 601 may comprise a lip 607 to aid in consumption or use of the contents of the container 602. In an embodiment, as illustrated in FIGS. 22-24, the sliding cover 603 is open when an effervescent composition 605 is put into the receptacle for effervescent composition 604. The sliding cover 603 slides clockwise viewed looking down on the lid 601. In FIG. 25 the sliding cover 603 slides counterclockwise viewed looking up at the bottom of the lid 603. In an aspect, as the sliding cover 603 begins to close it makes contact with the effervescent composition 605 and pushes it along an arc 606 on the underside of the lid 601. The arc 606 may be raised. In an aspect the sliding cover 603 slides underneath a cut out in the lid 601. In an embodiment, the arc 606 guides the effervescent composition 605 until it is swept off the receptacle for effervescent composition 604 into the container 602 with water or water-based liquid. In another embodiment, a component of the receptacle for effervescent composition 604 may bend to allow the effervescent composition 605 to fall down rather than be guided to the center of the container 602. In an embodiment where the receptacle 604 has the ability to bend, the volume capacity of the receptacle for effervescent composition may be variable. In another embodiment, the sliding cover 603 component and function could be straight rather than arced. In an embodiment, the opening is closed and may be sealed by the sliding cover 603 when the effervescent composition 605 is swept off the receptacle. In another aspect, after the water or water-based liquid is carbonated, the sliding cover 603 may be opened and the carbonated water or water-based liquid may be consumed or used.

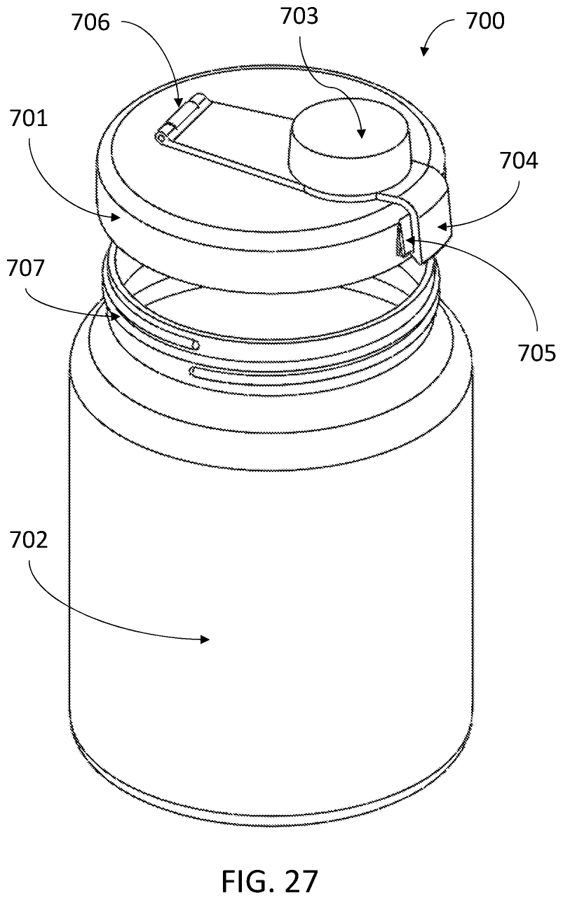

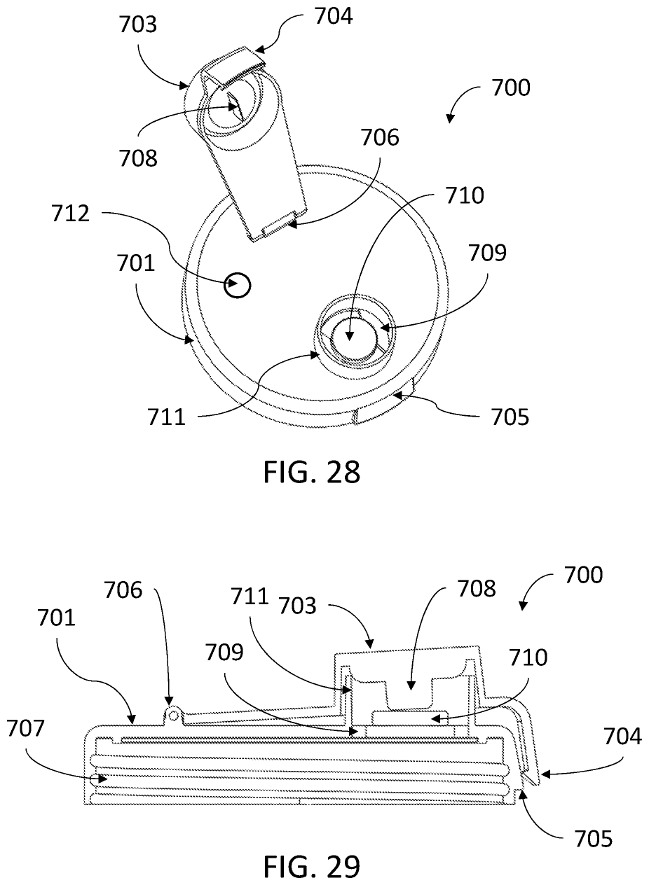

Referring to FIG. 27-29, an embodiment of an apparatus and systems to carbonate water or water-based liquid by delivering an effervescent composition ACWEC 700 is illustrated according to certain aspects of the disclosure. In an aspect, the ACWEC 700 may comprise a lid 701. In another aspect, the ACWEC 700 may comprise a container 702. In one embodiment, the lid 701 may attach to the container 702 with threads 707. In another embodiment not depicted, an alternative mechanism to threads 707 may secure the lid 701 to the container 702. In an embodiment, the ACWEC 700 may contain a cap 703 and the lid may comprise the cap 703. The cap 703 may be a flip cap or other type of cap and may clip 704 onto a catch 705 on the side of the lid 702 to secure it and close an opening. In an alternate embodiment, a buckle or latch may be used to keep the cap 703 closed. Furthermore, in another embodiment, a hinge on the side of a container 702 may eliminate the threads 707 and the lid 701 may be held closed by a buckle or latch. The cap 703 may function to deliver the effervescent composition 710 or may also function as the location of an opening for use or consumption of the container 702 contents. In an embodiment, the cap may be attached to an arm secured to the lid 701 with a hinge 706. In an aspect, the hinge 706 may comprise metal, plastic or other polymer. In an embodiment, an effervescent composition 710 may be placed in a receptacle for effervescent composition 709. In an aspect, the receptacle for effervescent composition 709 may flex or may be ridged. In an embodiment, the receptacle for effervescent composition 709 may comprise silicone, metal, plastic or other BPA free polymer. In an embodiment, the cap 703 may comprise a poker 708. In an aspect, the poker 708 may contact the effervescent composition 710 when the cap 703 is closed. In an embodiment, closing the cap 703 is the mechanism or action to release the effervescent composition from the receptacle 709. In an aspect, the effervescent composition 710 may be pushed by the poker 708 through a flexible receptacle for effervescent composition 709 into the water or water-based liquid. In an alternative aspect, the effervescent composition 710 may be snaped or broken by the poker 708 allowing the effervescent composition 710 to fall through the opening and into the water or water-based liquid. In an alternate embodiment, the receptacle for effervescent composition 709 may be loaded with an effervescent composition 710 contained in an aluminum pod. In this alternate embodiment, the effervescent composition 710 is ejected from the aluminum pod when contacted by the poker 708 and released into the water or water-based liquid. In an aspect, when the cap 703 is shut the opening of the container may be closed and may be sealed. In an embodiment, the lid 701 may contain a manual or automatic pressure release mechanism 712 as a safety mechanism. In another aspect, the lid 701 may contain a drinking spout 711. In another aspect, after the water or water-based liquid has been carbonated, the ACWEC 700 may be used or consumed from by removing the lid 701. In yet another embodiment, the cap 703 may contain more than one poker 708 or a larger poker 708 and the receptacle for effervescent composition 709 may contain a single rod or piece in the center which may flex, flex on a spring, or be rigid.

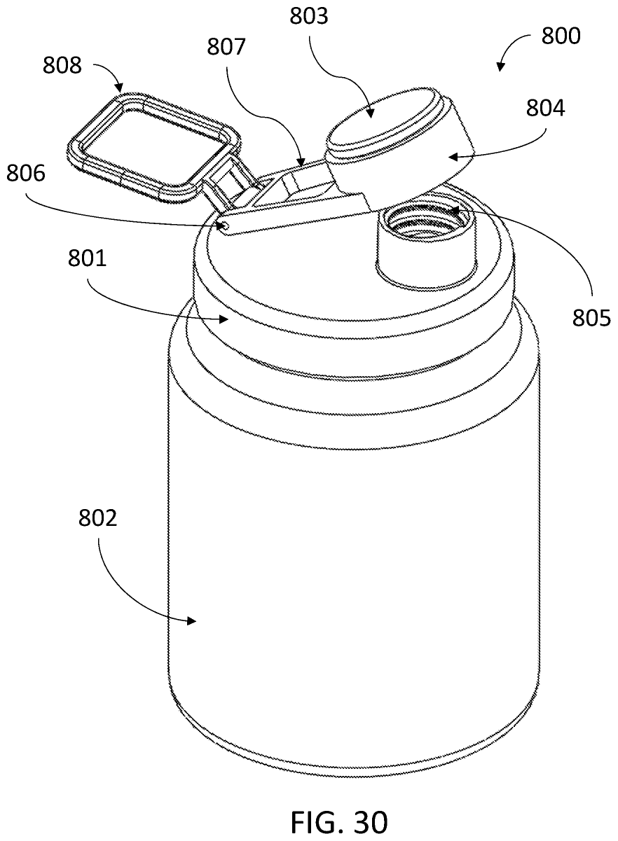

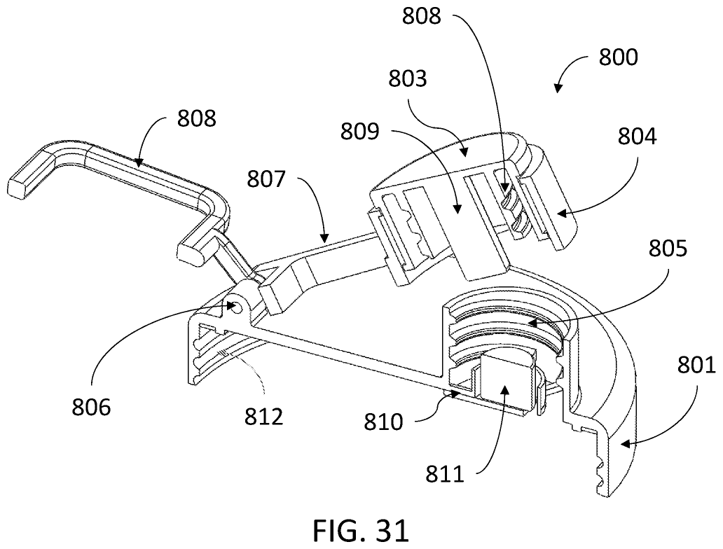

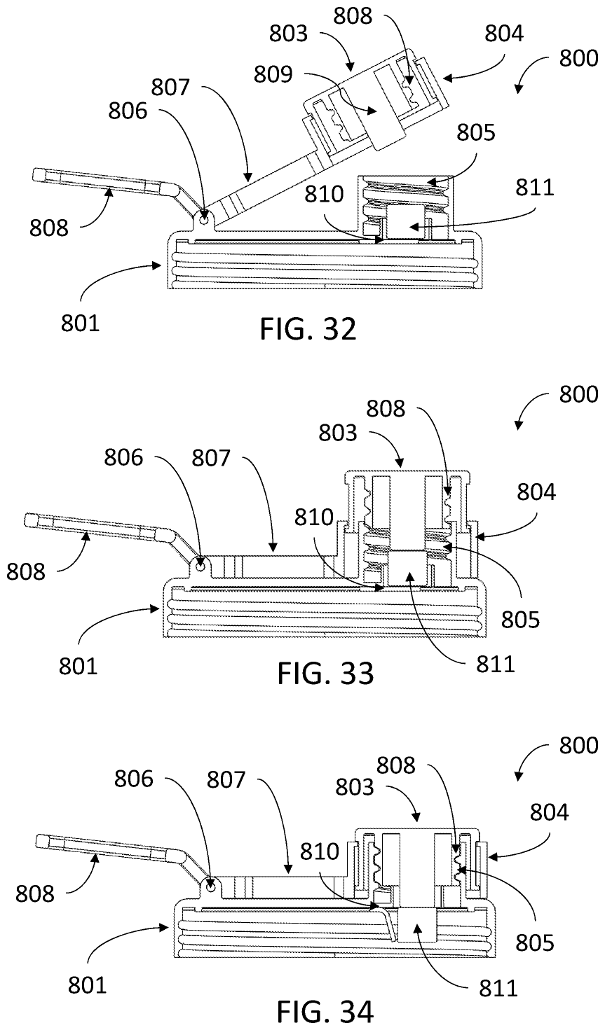

Referring to FIG. 30-34, an embodiment of an apparatus and systems to carbonate water or water-based liquid by delivering an effervescent composition ACWEC 800 is illustrated according to certain aspects of the disclosure. In an aspect, the ACWEC 800 may comprise a lid 801. In another aspect, the ACWEC 800 may comprise a container 802. In one embodiment, the lid 801 may attach to the container 802 with threads 812. In an embodiment, the lid 801 may comprise a hinge 806, a mobile handle 808, a cap 803 independent from cap seat 804, and a cap arm 807. In an aspect, the cap 803 may rotate freely within the cap seat 804. In an embodiment, an effervescent composition 811 may be placed in the receptable for effervescent composition 810 and the cap may be lowered onto the opening. In this embodiment, the cap containing male threads 808 and a pusher 809 may be threaded onto the opening containing female threads 805. In this embodiment, the cap 803 may be threaded onto the opening and the pusher 809 may push the effervescent composition 811 through the receptacle containing effervescent composition 810 into the water or water-based liquid. In this aspect, the threading is the mechanism or action to release the effervescent composition from the receptacle 810. In an aspect, the lid 801 and the cap 803 may each contain a seal or gasket. In an aspect, when the cap is closed, the opening may be closed or sealed. In yet another aspect, either the cap containing male threads 808 or the opening containing female threads 805 may comprise a stopper to prevent overtightening on a gasket. In an aspect, the cap male threading 808 and the opening female threading 805 may comprise a pressure release mechanism such as a gasket. There are many possible embodiments to the particular design of the receptacle containing effervescent composition 810 further contained in the disclosure. In another aspect, once the water or water-based liquid is carbonated, the contents may be consumed or used by opening either the cap 803 or the lid 801.

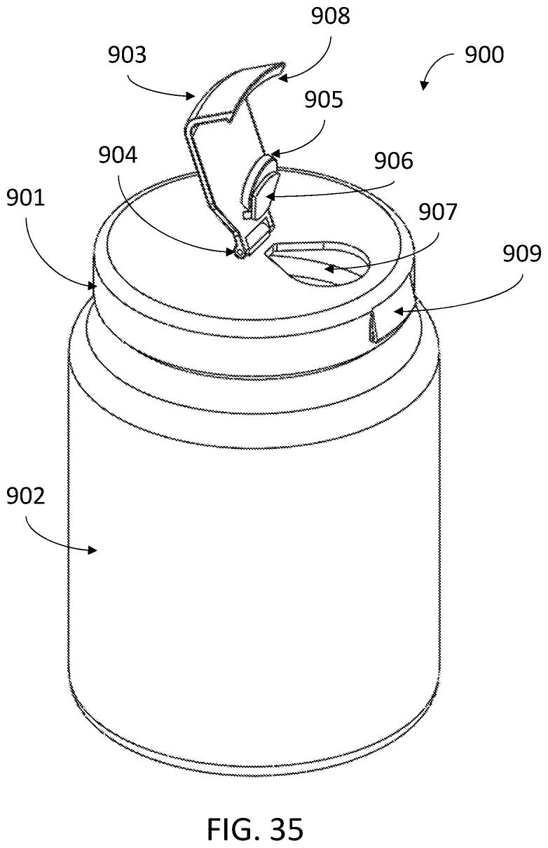

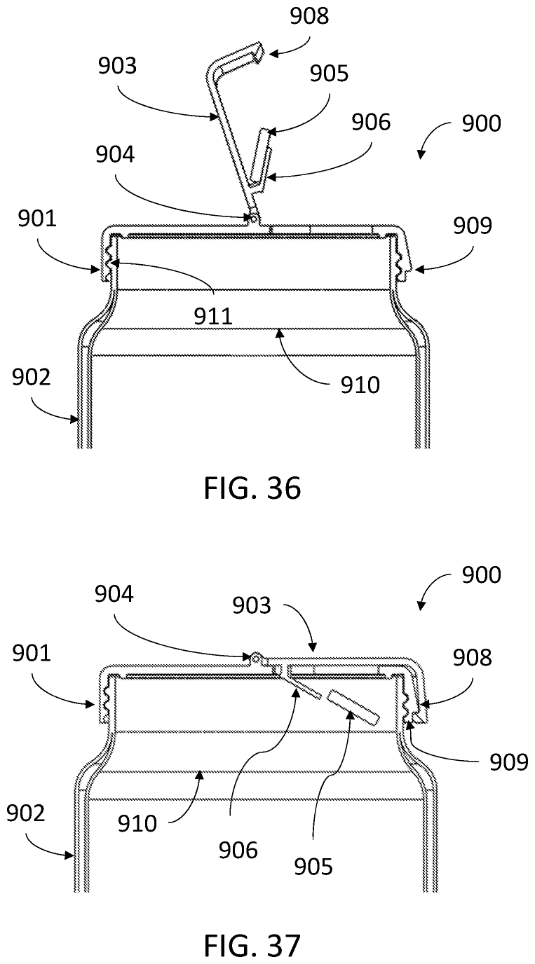

Referring to FIG. 35-37, an embodiment of an apparatus and systems to carbonate water or water-based liquid by delivering an effervescent composition ACWEC 900 is illustrated according to certain aspects of the disclosure. In an aspect, the ACWEC 900 may comprise a lid 901. In another aspect, the ACWEC 900 may comprise a container 902. In one embodiment, the lid 901 may attach to the container 902 with threads 911 as depicted in FIG. 36. In an alternative embodiment, the lid 901 and container 902 threads 911 may be replaced entirely with a hinged lid 901 with buckle latch. In one embodiment, a flip lid 903 may close and latch 908 onto a catch 909. In this embodiment, when the flip lid 903 is closed the opening 907 may be closed and sealed. In an aspect, the flip lid 903 may comprise a hinge 904 that allows it to open and close. In an alternative embodiment, the flip lid may comprise a buckle mechanism instead of or in addition to a latch 908 and catch 909. In an embodiment, an effervescent composition 905 may be placed on the receptacle for effervescent composition 906 which is attached to the underside of the flip lid 903. The flip lid 903 is lowered and the effervescent composition 905 is released falling past the water line 910 and into the water or water-based liquid. In an aspect, when the contents are carbonated the flip lid 903 may be opened and the opening 907 may be used to consume, access, or otherwise use the water or water-based liquid.

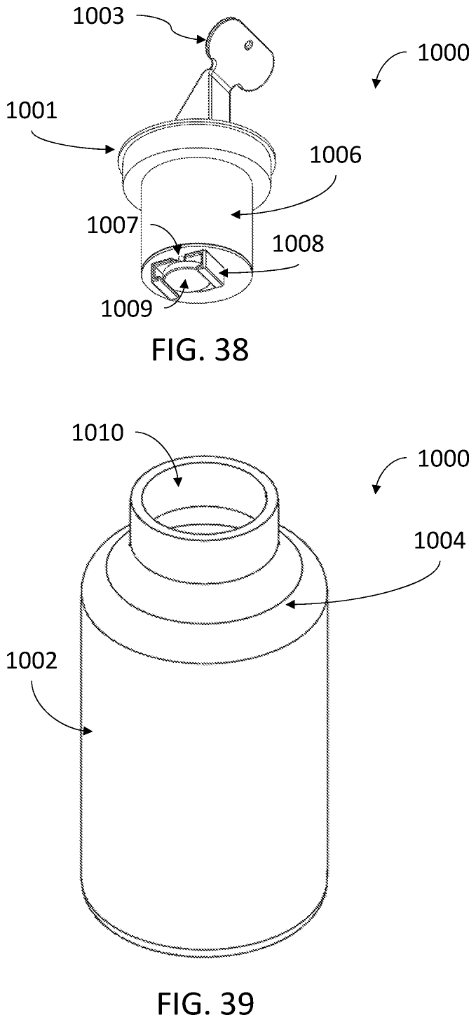

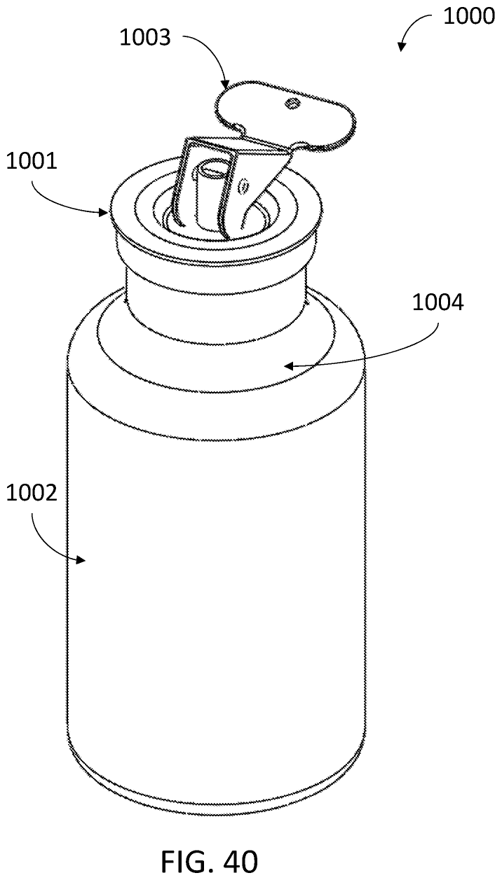

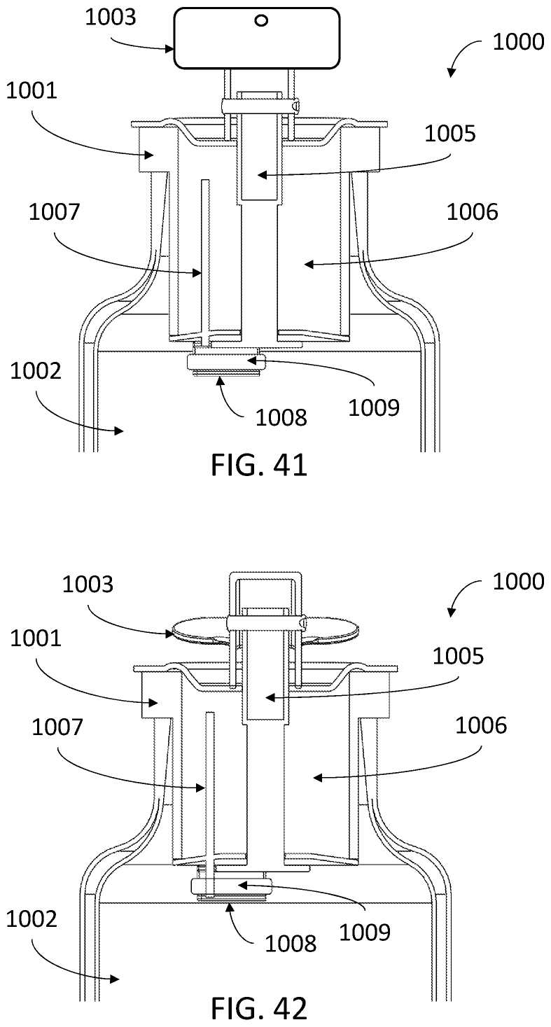

Referring to FIG. 38-42, an embodiment of an apparatus and systems to carbonate water or water-based liquid by delivering an effervescent composition ACWEC 1000 is illustrated according to certain aspects of the disclosure. In an aspect, the ACWEC 1000 may comprise a lid 1001. In another aspect, the ACWEC 1000 may comprise a container 1002. In an embodiment the container may comprise specific curvature or shape 1004. In an embodiment, the lid may comprise an expansion plug 1006. In an aspect, the expansion plug 1006 may be rated for pressure between 5-200 PSI or 10-100 PSI or 50 PSI and may be composed of rubber or silicone. In yet another aspect, the expansion plug 1006 may expand into a container 1002 with a straight or tapered neck or underneath a shoulder. In an aspect, the expansion plug may be activated with a lever 1003 and a plunger 1005 may contract the expansion plug 1006. In an aspect, the lever 1003 may be a cam lever. In an embodiment, the receptacle for effervescent composition 1008 may be located on the bottom of the plug 1006. In an aspect, a fixed pin 1007 may be set inside of the plug 1006 and lid 1001. In an embodiment, the fixed pin 1007 may or may not be embedded in the plug 1006 and may or may not pass completely through the plug 1006 on either side. In an embodiment, the plunger may comprise the fixed pin or other durable component. In an aspect, any metal parts may be coated with plastic, silicone, rubber, or other polymer. In an embodiment the receptacle for effervescent composition 1008 is loaded with an effervescent composition 1009 and the plug 1006 is placed inside of the opening 1010. In an aspect, when the lever 1003 is activated the plug 1006 may contract in length and the sides may expand which may close or seal the opening 1010. In an aspect, when the lever 1003 is activated the plug 1006 may contract in length and the receptacle for effervescent composition 1008 may be lifted upward. In yet another aspect, when the receptacle for effervescent composition 1008 is lifted upward the fixed pin 1007 may pass through the effervescent composition breaking it and causing it to fall into the water or water-based liquid. In another embodiment, when the receptacle for effervescent composition 1008 is lifted upward the fixed pin 1007 or other durable fixed component may push the effervescent composition 1009 through the receptacle for effervescent composition 1008 and into the water or water-based liquid. In an embodiment, when the contents are carbonated, the lever 1003 may be released and the lid 1001 may be removed from the container 1002 to access, consume, or otherwise use the water or water-based liquid contents.

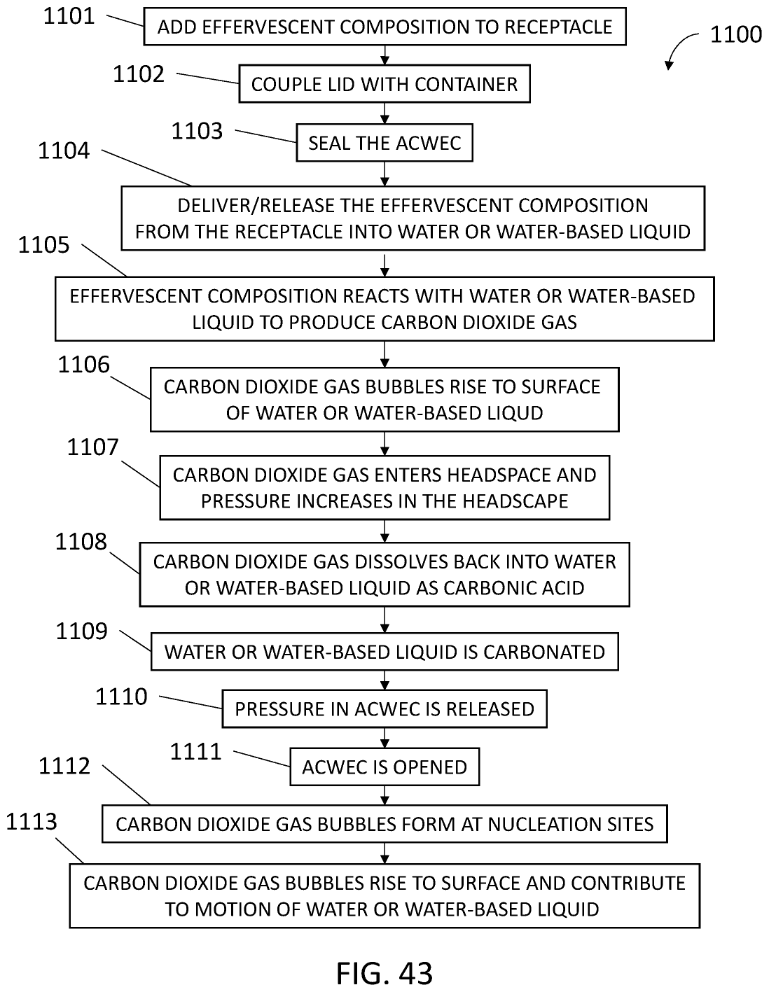

Referring to FIG. 43, an embodiment of a method for carbonating water or water-based liquid by delivering an effervescent composition by an apparatus and the systems thereof 1100 is illustrated according to certain aspects of the disclosure. At step 1101, an effervescent composition is added to the receptacle. Step 1101 may be omitted. At step 1102, the lid is coupled with the container. Step 102 may occur before step 1101. At step 1103, the ACWEC is sealed. At step 1104, the effervescent composition is released or delivered from the receptacle into water or water-based liquid. Step 1104 may occur at the same time as step 1103. At step 1105, the effervescent composition reacts with water or water-based liquid to produce carbon dioxide gas. At step 1106, carbon dioxide gas bubbles rise to the surface of the water or water-based liquid. At step 1107, carbon dioxide gas enters the headspace and pressure increases in the headspace. At step 1108, carbon dioxide gas dissolves back into the water or water-based liquid as carbonic acid. At step 1109, the water or water-based liquid is carbonated. At step 1110, pressure in the ACWEC is released. Step 1110 may occur at step 1107. At step 1111, the ACWEC is opened. At step 1112, carbon dioxide gas bubbles form at nucleation sites. Step 1112 may occur at after step 1105 and before step 1106. At step 1113, carbon dioxide gas bubbles rise to the surface and contribute to the motion of water or water-based liquid.

In an embodiment, an apparatus and systems to carbonate water or water-based liquid by delivering an effervescent composition (ACWEC) is disclosed. In an embodiment, the ACWEC may comprise an effervescent composition. In an embodiment, the effervescent composition may be inside a sealed ACWEC. In an embodiment, the effervescent composition may be outside a sealed ACWEC. An effervescent composition may contain an acid and a base. The base may be a carbonate or bicarbonate. When an effervescent composition comes into contact with water or a water-based liquid it reacts to produce carbon dioxide gas and other products.

It is expressly understood that the words “degassing”, “outgassing”, “bubbling”, and “effervescing” each expressly mean the release of carbon dioxide gas from water or water-based liquid.

It is expressly understood that the term “acid” means an acid or substance that contains an acid that can react with a base. An acid may be an acid yielding compound. An acid may be a molecule or other entity that can donate a proton or accept an electron pair in reactions. An acid may be described by Arrhenius, Brønsted-Lowry, and Lewis definitions of acids.

In one embodiment, the acid may include citric acid, tartaric acid, oxalic acid, or other acid.

It is expressly understood that the term “base” means a base or substance that contains a base that can react with an acid. A base may be an alkali compound. A base may be a molecule or other entity that can accept a proton or donate an electron pair in reactions. A base may be described by Arrhenius, Brønsted-Lowry, and Lewis definitions of bases.

In one embodiment, the base may be a carbonate and may include sodium carbonate or other carbonate. In another embodiment, the base may be a bicarbonate and may include potassium bicarbonate, sodium bicarbonate, ammonium bicarbonate, calcium bicarbonate, magnesium bicarbonate or other bicarbonate. The base may include another base.

In some embodiments, the acid may include acetic acid, adipic acid, amino acids, arsenic acid, arsenious acid, ascorbic acid, benzoic acid, boric acid, carbonic acid, chloric acid, chromic acid, citric acid, citric acid anhydride, ethanoic acid, formic acid, heteropolyoxometallates, hydrobromic acid, hydrochloric acid, hydrofluoric acid, hydrogen selenide, hydrogen sulfate ion, hydrogen sulfide, hydroiodic acid, isocyanic acid, lactic acid, maleic acid, malic acid, malonic acid, methanoic acid, molybdic acid, nicotinic acid, niobic acid, nitric acid, nitrous acid, orthophosphoric acid, oxalic acid, oxides of titania, zirconia, and niobia, perchloric acid, phosphoric acid, potassium dihydrogenphosphate, p-toluene sulfonic, selenic acid, selenous acid, silicic acid, silicic acid (with SiO2(a) precipitation), silico-aluminates (zeolites, alumina, silico-aluminophosphate), sodium dihydrogenphosphate, sodium fumarate, solid Brønsted acids, succinic acid, succinic acid anhydride, sulfated zirconia, sulfonated polystyrene, sulfuric acid, sulfurous acid, sulphamic acid, and tartaric acid.

In some embodiments, the carbonate may include aluminium carbonate, ammonium carbonate, ammonium sesquicarbonate, ammonium uranyl carbonate, arginine carbonate, barium carbonate, basic copper carbonate, beryllium carbonate, bismuth subcarbonate, borate carbonate, caesium carbonate, calcium carbonate, caliche, carbonate chloride, carbonate oxalate, carbonatobis(ethylenediamine)cobalt(III) chloride, carbonic acid, cerium(III) carbonate, cobalt(II) carbonate, copper(II) carbonate, fluorocarbonate, iron(II) carbonate, lanthanum carbonate, lead carbonate, lithium carbonate, L-lysine carbonate, magnesium carbonate, manganese(II) carbonate, mesoporous magnesium carbonate, nickel(II) carbonate, potassium carbonate, potassium sequicarbonate, radium carbonate, rubidium carbonate, siderite, silicon carbonate, silver carbonate, sodium carbonate, sodium glycine carbonate, sodium percarbonate, sodium sesquicarbonate, strontium carbonate, sulfate carbonate, thallium(I) carbonate, thiocarbonate, uranyl carbonate, and zinc carbonate.

In some embodiments, the bicarbonate may include potassium bicarbonate, ammonium bicarbonate, sodium bicarbonate, caesium bicarbonate, calcium bicarbonate, lithium bicarbonate, and magnesium bicarbonate.

In some embodiments, the effervescent composition may only comprise effervescent ingredients. In another embodiment, the effervescent composition may be added to a water-based liquid that contains active, beneficial, or functional ingredients to carbonate the liquid. For example, a flavored water-based liquid that is flat or void of carbonation may be carbonated with an effervescent composition comprising only effervescent ingredients. In yet other embodiments, the effervescent composition may include other ingredients such as flavors, sweeteners, colors, fragrance, nutrients, proteins, probiotics, vitamins, amino acids, enzymes, organism derived ingredients, microorganisms, biostimulants, cleaners, pesticides, surfactants, lubricants, fillers, binders, carriers, and other active, beneficial or functional ingredients.

In an embodiment, the presence of other substances in the water or water-based liquid such as surfactants, oils, alcohol, proteins, enzymes, other functional ingredients, or byproducts may affect the surface tension, viscosity, density and other properties of the water or water-based liquid such as foaming or foam persistence. In an embodiment, the presence of other substances may affect the formation, size, motion, surface stability, or lifetime of carbon dioxide bubbles and impact rate or ability of carbon dioxide gas to dissolve back into liquid as carbonic acid, carbonating the water or water-based liquid contents.

In an embodiment, an effervescent composition may be in any substantially dry or solid form. In another embodiment, the effervescent composition may be in a loose form such as a powder, meal, pellets, or granules. In yet another embodiment, the effervescent composition may comprise a tablet or capsule. In another embodiment, the effervescent composition comprising a tablet, capsule, coating, or other compact or contained form, may be round, oblong, oval, square, rectangular and may comprise a cylinder, disk, cube, rectangular cuboid, cone, sphere, triangular pyramid, square pyramid, torus, capsule, almond, pentagon, oval, lozenge, pill, ball, modified ball, compound cup, convex bevel edge, diamond, core rod, triangular prism, or other shape. In another embodiment the effervescent composition comprising a tablet or capsule, or other compact or contained form, may be flat faced, shallow convex, normal convex, deep convex, flat face beveled edge, flat face radius edge, double radius, bevel and convex, dimple, rim, ring, ellipse, hexagon, heptagon, octagon, pillow, barrel, arrowhead, bullet, half moon, shield, heart, star, or other shape. In other embodiments the receptacle for effervescent composition may fit or otherwise receive a loose composition or a compact or contained composition in any of the described shapes or forms.

In an embodiment, the effervescent composition may comprise a coating. In an embodiment, the coating may protect the effervescent composition from water vapor, water, or water-based liquid. In an embodiment the coating may comprise a slow dissolve component. In an embodiment, the coating may comprise polyvinyl alcohol (PVA), a derivative of PVA, sugar coating, film coating, enteric coating, binders, acacia, gelatin, cellulose derivative, shellac, filler, calcium carbonate, titanium dioxide, talc, colorants, dye, iron oxides, titanium dioxide, antiadhesives, talc, and other coatings.

In another embodiment the effervescent composition comprising a loose, compact, or contained form may comprise a pod, casing, cartridge, or other primary packaging. The pod, casing, cartridge, or other primary packaging may be aluminum, plastic, paper, or a combination thereof. The pod, casing, cartridge, or other packaging may be single-use, disposable, recyclable, compostable, interchangeable, or reusable. In an embodiment the pod, casing, cartridge, other packaging, or a coating may be hermetically sealed, create a hermetic sealed, or fully or partially prevent water vapor from initiating a chemical reaction of the effervescent composition. In an embodiment the pod, casing, cartridge, other packaging, or a coating may allow the effervescent composition to be loaded into the lid, container, or effervescent composition receptacle and allow for use or consumption at a later time or date other than immediately. For example, a functional beverage effervescent composition may be loaded into the effervescent composition receptacle, container, or lid and then consumed hours or days later.

In an embodiment, the effervescent composition, that may or may not comprise any additional ingredients other than an acid and a base, may weigh between about 0.1 grams to about 1,000 grams. In another embodiment, the effervescent composition that may or may not comprise any additional ingredients other than an acid and a base, may comprise between about 1 gram to about 100 grams. In a preferred embodiment, the effervescent composition that may or may not comprise any additional ingredients other than an acid and a base, may comprise between about 2 grams to about 20 grams. In yet another preferred embodiment, the effervescent composition that may or may not comprise any additional ingredients other than an acid and a base, may comprise between about 3 grams to about 12 grams. In yet another preferred embodiment, the effervescent composition that may or may not comprise any additional ingredients other than an acid and a base, may comprise between about 3 grams to about 6 grams. In a preferred embodiment, the effervescent composition that may or may not comprise any additional ingredients other than an acid and a base, may comprise about 2.9, 3, 3.2, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, 11.9, 12, 12.1, or 12.2 grams.

In some embodiments the effervescent composition may contain an acid comprising between about 1% by mass to about 99% by mass. In some embodiments the acid may comprise about 5.1% by mass, 10.1% by mass, 15.1% by mass, 20.1% by mass, 25.1% by mass, 30.1% by mass, 35.1% by mass, 40.1% by mass, 45.1% by mass, 50.1% by mass, 55.1% by mass, 60.1% by mass, 65.1% by mass, 70.1% by mass, 75.1% by mass, 80.1% by mass, 85.1% by mass, 90.1% by mass, or 95.1% by mass.

In some embodiments the effervescent composition may contain a carbonate comprising between about 1% by mass to about 99% by mass. In some embodiments the carbonate may comprise about 5.1% by mass, 10.1% by mass, 15.1% by mass, 20.1% by mass, 25.1% by mass, 30.1% by mass, 35.1% by mass, 40.1% by mass, 45.1% by mass, 50.1% by mass, 55.1% by mass, 60.1% by mass, 65.1% by mass, 70.1% by mass, 75.1% by mass, 80.1% by mass, 85.1% by mass, 90.1% by mass, or 95.1% by mass.

In some embodiments the effervescent composition may contain a bicarbonate comprising between about 1% by mass to about 99% by mass. In some embodiments the bicarbonate may comprise about 5.1% by mass, 10.1% by mass, 15.1% by mass, 20.1% by mass, 25.1% by mass, 30.1% by mass, 35.1% by mass, 40.1% by mass, 45.1% by mass, 50.1% by mass, 55.1% by mass, 60.1% by mass, 65.1% by mass, 70.1% by mass, 75.1% by mass, 80.1% by mass, 85.1% by mass, 90.1% by mass, or 95.1% by mass.

In some embodiments the mass ratio of bicarbonate to acid is about 1.56. In other embodiments the mass ratio bicarbonate to acid is about 1.31. In another embodiment the mass ratio of carbonate to acid is about 0.83. In another embodiment the mass ratio of base to acid is about 0.5 to about 2.

In an embodiment, one gram of bicarbonate can generate about 0.43959 grams carbon dioxide. In another embodiment, one gram of bicarbonate can generate about 0.52388 grams carbon dioxide. In yet another embodiment on gram of carbonate can generate about 0.41523 grams carbon dioxide. In another embodiment, one gram of base, bicarbonate, or carbonate may generate about 0.3 grams to about 0.7 grams carbon dioxide.

In an embodiment, one gram of effervescent composition, acid, base, carbonate, or bicarbonate can comprise a volume of about 0.032681159 cubic inches or about 0.53554942 cubic centimeters when compressed, compacted, or in a contained form. In another embodiment, one gram of effervescent composition, acid, base, carbonate, or bicarbonate can comprise a volume of about 0.016340579 cubic inches to about 0.065362318 cubic inches or about 0.26777471 cubic centimeters to about 1.07109884 cubic centimeters when compressed, compacted, or in a contained form. In yet another embodiment, one gram of effervescent composition, acid, base, carbonate, or bicarbonate can comprise a volume of about 0.032681159 cubic inches to about 0.32681159 cubic inches or about 0.53554942 cubic centimeters to about 5.3554942 cubic centimeters when in a loose form. In another embodiment, one gram of effervescent composition, acid, base, carbonate, or bicarbonate can comprise a volume of about 0.0163 cubic inches to about 0.327 cubic inches or about 0.268 cubic centimeters to about 5.355 cubic centimeters.

In an embodiment the effervescent composition may react in water or water-based liquid and produce, dissolve, or release carbon dioxide in the amount of about 0.0001 grams CO2 per fl. oz. water or water-based liquid to about 0.017 grams CO2 per fl. oz. water or water-based liquid. In an embodiment the effervescent composition may react in water or water-based liquid and produce, dissolve, or release carbon dioxide in the amount of about 0.017 grams CO2 per fl. oz. water or water-based liquid to about 0.35 grams CO2 per fl. oz. water or water-based liquid. In another embodiment the effervescent composition may react in water or water-based liquid and produce, dissolve, or release carbon dioxide in the amount of about 0.1 grams CO2 per fl. oz. water or water-based liquid to about 0.27 grams CO2 per fl. oz. water or water-based liquid. In another embodiment the effervescent composition may react in water or water-based liquid and produce, dissolve, or release carbon dioxide in the amount of about 0.14 grams CO2 per fl. oz. water or water-based liquid to about 0.23 grams CO2 per fl. oz. water or water-based liquid. In another embodiment the effervescent composition may react in water or water-based liquid and produce, dissolve, or release carbon dioxide in the amount of about 0.15 grams CO2 per fl. oz. water or water-based liquid to about 0.22 grams CO2 per fl. oz. water or water-based liquid. In another embodiment the effervescent composition may react in water or water-based liquid and produce, dissolve, or release carbon dioxide in the amount of about 0.158 grams CO2 per fl. oz. water or water-based liquid to about 0.208 grams CO2 per fl. oz. water or water-based liquid. In another embodiment the effervescent composition may react in water or water-based liquid and produce, dissolve, or release carbon dioxide in the amount of about 0.167 grams CO2 per fl. oz. water or water-based liquid to about 0.2 grams CO2 per fl. oz. water or water-based liquid. In another embodiment the effervescent composition may react in water or water-based liquid and produce, dissolve, or release carbon dioxide in the amount of about 0.175 grams CO2 per fl. oz. water or water-based liquid to about 0.192 grams CO2 per fl. oz. water or water-based liquid. In another embodiment the effervescent composition may react in water or water-based liquid and produce, dissolve, or release carbon dioxide in the amount of about 0.183333 grams CO2 per fl. oz. water or water-based liquid. In another embodiment the effervescent composition may react in water or water-based liquid and produce, dissolve, or release carbon dioxide in the amount of about 3 grams CO2 per liter water or water-based liquid. In another embodiment the effervescent composition may react in water or water-based liquid and produce, dissolve, or release carbon dioxide in the amount of about 3 grams CO2 per liter water or water-based liquid at a temperature of about 45ºF or 8° C. Henry's constant for CO2 in water at 12° C. (53.6° F.) is 1.9 g/L· atm.

In an embodiment, the minimum volume capacity of the receptacle for effervescent composition may comprise about 0.03 cubic centimeters per fluid ounce volume capacity for water or water-based liquid. In another embodiment, the minimum volume capacity of the receptacle for effervescent composition may comprise about 0.0003 cubic centimeters per fluid ounce volume capacity for water or water-based liquid to about 3 cubic centimeters per fluid ounce volume capacity for water or water-based liquid.

In an embodiment, the ratio of the volume capacity of the receptacle for effervescent composition to the volume capacity of the water or water-based liquid must be greater than about 1:986. In another embodiment, the ratio of the volume capacity of the receptacle for effervescent composition to the volume capacity of the water or water-based liquid must be greater than about 1:9860. In another embodiment, the ratio of the volume capacity of the receptacle for effervescent composition to the volume capacity of the water or water-based liquid must be greater than about 1:98.

In an embodiment, the volume capacity of water or water based liquid may be the container volume capacity for water or water-based liquid and vice versa. In one embodiment, the water or water-based liquid, volume of water or water-based liquid, volume capacity of water or water-based liquid may be the same as the container volume, container volume capacity, container volume capacity for water or water-based liquid. In other embodiments, the water or water-based liquid, volume of water or water-based liquid, volume capacity of water or water-based liquid may be different from the container volume, container volume capacity, container volume capacity for water or water-based liquid.

In an embodiment, the effervescent composition dissolve time when mixed with water or water-based liquid may be about 1 second to about 24 hours. In another embodiment, the effervescent composition dissolve time when mixed with water or water-based liquid may be about 30 second to about 1 hour. In another embodiment, the effervescent composition dissolve time when mixed with water or water-based liquid may be about 1 minute to about 10 minutes. In another embodiment, the effervescent composition dissolve time when mixed with water or water-based liquid may be about 2 minutes to about 5 minutes. In another embodiment, the dissolve time may be up to 7 days.

In an embodiment, the carbonation effervescent degas time, when the water or water-based liquid has been carbonated from the effervescent composition and then the container is opened, may be about 1 second to about 24 hours. In an embodiment, the carbonation effervescent degas time, when the water or water-based liquid has been carbonated from the effervescent composition and then the container is opened, may be about 30 second to about 2 hours. In an embodiment, the carbonation effervescent degas time, when the water or water-based liquid has been carbonated from the effervescent composition and then the container is opened, may be about 1 minute to about 1 hour. In an embodiment, the carbonation effervescent degas time, when the water or water-based liquid has been carbonated from the effervescent composition and then the container is opened, may be about 2 minutes to about 30 minutes.

In an embodiment, the composition may be specialized, consumed, or otherwise used by a human, male, female, infant, child, adolescent, adult, animal, plant, fungi, bacterium, virus, or any other organism.

In an embodiment, the ACWEC comprises a lid. The lid may comprise the receptacle for effervescent composition. The lid may contain a mechanism or action to release effervescent composition. In an embodiment, the mechanism or action to release effervescent composition may be a delivery device. In other embodiments, the delivery device may be a mechanism or action to release an effervescent composition. The lid may contain a seal. The lid may contain a mechanism to release pressure. The lid may contain an opening. The lid may contain the volume capacity for headspace.

In an embodiment, the lid may or may not operate independently from the container. The lid may fit a reusable container. The lid may fit a single-use or reusable receptacle for effervescent composition. The lid may fit threads of a reusable container. A reusable container may be a reusable water bottle. A reusable container may comprise a wide mouth or narrow mouth. In an embodiment, the lid may comprise a diameter between about one centimeter to about one meter and every possible value between.

In an embodiment, the lid may fit a used single-use container and repurpose it. The lid may fit a glass bottle, plastic bottle, ceramic bottle, metal bottle, mason jar, or other single-use container that may be repurposed. The lid may fit any single-use container type or fit the threads of any single-use container type. A single-use container may comprise a wide mouth or narrow mouth. A single-use container may comprise a mouth between about one centimeter to about 12 inches and every possible value between. The lid may fit a new single-use container. A new single-use container may comprise the lid.

In an embodiment, the lid may be opened, closed, tightened, untightened, secured, unsecured, sealed, unsealed, ajar, partially open, partially closed, partially threaded, or partially unthreaded. In an aspect, the lid is not open when it is closed, untightened, unsecured, unsealed, ajar, partially open, partially closed, partially threaded, or partially unthreaded. The lid may comprise one piece, two pieces, three pieces, or more than three pieces. The lid may contain one, two, three, or more openings for different functions. Any piece or opening may contain a seal or be sealable. Any component of the lid may be sealed, unsealed, or resealed to the lid or the container. The lid may be locked into place, locked, or unlocked.

In an embodiment the lid may hold pressure. In an aspect, the lid may hold between about 5 PSI to about 300 PSI and every possible value between. The lid may apply counter pressure to, contain a component to apply counter pressure to, or contain a cap to apply counter pressure to a seal. The lid may contain one, two, or more caps. The cap may be a threaded cap or screw cap.

In an embodiment, the lid may comprise a latch, lock, catch, clamp, snap, slide, slider, sliding cover, cover, clip, tab, pull-tab, ring, pull-ring, plunger, cam-lock plunger or any other functional mechanism. The lid may contain a spring. The spring may be a compression, extension, torsion, or constant force spring.

In an embodiment, the lid may comprise a drink delivery device. In various embodiments, the drink delivery device may comprise an opening, straw lid, flex lid, straw-flex lid, flip straw lid, flip lid, screw-top lid, slider lid, straw cap, or any other available lid type. In other embodiments, the drink delivery device may comprise an opening, tap, spout, drinking spout, dispenser, straw, lip, spray head, nozzle, or cap. The nozzle may be flat-fan, flood, raindrop, hollow-cone, or full-cone. The lid may contain a straw, flex straw, or flip straw.

In an embodiment, the lid, drink delivery device, straw, or any other component of the ACWEC may comprise bubble nucleation sites.

In an embodiment, the container may comprise an infuser. An infuser may be built in or removable. An infuser may add flavor or other ingredient to water or water-based liquid.

In an embodiment, the lid may contain a mechanism to allow air into the container when being consumed from or otherwise used. The mechanism may prevent a vacuum inside the container or lid. The mechanism may be a vent or hole. The mechanism may be a one way valve.

In an embodiment, the lid may thread, screw, latch, snap, clip, fit, click, attach, close, open, seal, unseal, or otherwise be put on or removed from the container, the receptacle for effervescent composition, or another component of itself. The lid may comprise a swing-type closure.

In an embodiment, the lid may contain one or more handles. The lid may contain one or more hinges. The lid or any component of the lid may move, swivel, slide, be variable, be fixed, be separable, or be integrated. The lid may comprise a handle, integral handle, clip, or loop.

In an embodiment, the lid may contain one or more hinges. A hinge may be metal, plastic, acrylic, other polymer or any combination thereof. A hinge may be surface mounted or integral. A hinge may be located on an exterior or interior surface of the lid or any component of the lid, container, or receptacle for effervescent composition.

In an embodiment, the lid or any component of the lid may contain male or female threads. The lid or any component of the lid may contain internal threads or external threads. The threads may be coarse threads with a large amount of space between threads or fine threads with a small amount of space between threads. Coarse threads may move more distance than fine threads with fewer turns. In an aspect, coarse threads may be the mechanism or action to release effervescent composition from the receptacle. The lid or any threaded component may comprise a stopper to prevent over tightening, to prevent overtightening on a seal, or prevent over tightening on a gasket. The lid may contain one, two, three, or more than three sets of threads.

In an embodiment, the lid may contain one, two, three, or more seals. The seal be a gasket. A gasket may be located at the top of the thread, the bottom of thread, or anywhere else along the thread. A gasket may be used when a thread is not present.

In an embodiment, the lid may contain one, two, three or more openings. The opening may be used to fill the container with water or water-based liquid. The opening may be used to insert an amount of effervescent composition or insert a receptacle for effervescent composition. The opening may be used to consume, drink, or otherwise access the water or water-based liquid. The opening may allow access for cleaning. One or more components, or the lid itself, may be removed or opened to create an opening. In an embodiment, the lid may contain one, two, three, or more inner chambers.

In an embodiment, the lid may contain an indicator that indicates the level of carbonation, that the container is sufficiently carbonated, the level of pressure, or when pressure has been released. An indicator may comprise a signal, a light, a switch, a physical change, or a chemical change.

In an embodiment, the lid may contain a mechanism to decrease or increase pressure inside the container or headspace. The mechanism may comprise a manual or automatic pump. The mechanism may be pumped by hand or finger. The mechanism may comprise an attachment for a manual or automatic pump. The mechanism may be integral, removable, or may be a component to receive an attachment from another device or appliance.

In an embodiment, the lid may be an appliance or fit into an appliance. The lid or appliance may decrease or increase the temperature of water or water-based liquid or supply hot or cold water or water-based liquid to the container. The lid or appliance may produce or receive counter pressure during carbonation to prevent the seal from failing due to sudden pressure from carbonation. The lid or appliance may function to fill the container with water or water-based liquid to a precise volume or headspace. The lid or appliance may function to increase or decrease pressure in the headspace by pumping or releasing air or gas. The lid or appliance may cap or seal.

In an embodiment, the lid may be single-use, disposable, recyclable, compostable, interchangeable, or reusable. The lid and any component of the lid may comprise plastic, any metal, aluminum, stainless steel, glass, ceramic, PET (polyethylene terephthalate), HDPE (high-density polyethylene), silicone, rubber, any polymer, acrylic, clear acrylic or any material that the container or the receptable for effervescent composition may be composted of. The lid may comprise 8/8 stainless steel construction or polypropylene plastic resin (5 #plastic). The lid may comprise thermoplastic elastomer (TPE), PETE, nylon, low-density polyethylene or (LDPE), polypropylene (PP), or UV-resistant polyethylene.

In an embodiment, the lid may be BPA-Free, food-grade, or toxin-free. A product that is BPA-free is one that does not use the organic compound Bisphenol A in its construction.

In an embodiment, the lid may contain a metal component. In an embodiment, the lid may contain a magnet or magnetic material. Any metal or magnetic component may be coated, overmolded, or otherwise partially or fully covered with silicone, plastic, rubber, any polymer, or any other substance described in the specification. A coating or overmolding may provide protection, durability, or shape. A coating or overmolding may improve function, feel, or aesthetic.

In an embodiment, the lid comprises text, icons, or markings to illustrate instructions for use.

In an embodiment, the lid may comprise hardware and connect to the internet, Wi-Fi, or Bluetooth through a wireless or direct connection. The lid may transmit, send, or receive electronic information. The lid may contain an electronic sensor. The lid may contain an electronic switch. The lid may connect to other electronic devices such as a computer, mobile device, tablet, or network to transmit and receive signals and information. The lid may use signals or information to perform a function. The lid may contain a power source. The lid may contain a battery or rechargeable battery. They lid may comprise a charger or plug connection.

In an embodiment, the ACWEC comprises a container. The container may comprise the receptacle for effervescent composition. The container may contain a mechanism or action to release effervescent composition. The container may comprise a seal. The container may comprise a mechanism to release pressure. The container may contain an opening. The container may contain a volume capacity for headspace. The container may contain a volume capacity for water or water-based liquid.

In an embodiment, the container may or may not operate independently from the lid. The container may fit a single-use or reusable lid. The container may fit a single-use or reusable receptacle for effervescent composition.

In an embodiment, the ACWEC or container may be tipped on its side or flipped upside down.

In an embodiment, the container be a reusable container, single-use container, a glass bottle, plastic bottle, ceramic bottle, metal bottle, mason jar, or other single-use container that may be repurposed.

In an embodiment, the container may be unsealed, sealed, or resealed. The container may be locked into place, locked, or unlocked.

In an embodiment, the container may contain a magnet or magnetic material. In an embodiment, the container may include a magnet, magnetic material, or carbon steel overmolded with any polymer, plastic, rubber, or silicon.

In an embodiment, the container may comprise a material to retain a low temperature or high temperature of contents including water or water-based liquid. The container may comprise a material to moderate temperature. A lower temperature may increase the rate of carbon dioxide gas dissolving into water or water based liquid as carbonic acid when the container is closed. A lower temperature may decrease the rate of carbonic acid forming carbon dioxide gas effervescence and may extend carbonation duration when container is open. A low temperature may be preferable for consumption of the water or water-based liquid contents. A higher temperature may result in the opposite result. In an embodiment, the container may include a copper lining. The copper lining may be on the inner wall.

In an embodiment, the container may be single-use, disposable, recyclable, compostable, interchangeable, or reusable.

In an embodiment, the container may comprise, metal, aluminum, plastic, glass, ceramic, PET (polyethylene terephthalate), HDPE (high-density polyethylene), stainless steel, silicone, rubber, polymer, acrylic, clear acrylic, an aerogel layer, a hydrogel, or any material that the lid or the receptable for effervescent composition may be composted of. The container may comprise 8/8 stainless steel construction or polypropylene plastic resin (5 #plastic). The container may comprise thermoplastic elastomer (TPE), PETE, nylon, low-density polyethylene or (LDPE), polypropylene (PP), or UV-resistant polyethylene.

In an aspect, any aluminum component of the ACWEC may comprise aluminum grades 1100, 3003, 3004, 5050, 5052, 5082, 5086, 5154, or 6061.

In an aspect, the container or container walls may be insulated. The container may be insulated with foam or vacuum-sealed metal. The container may keep the water or water-based liquid at desired low or hot temperature. In an embodiment, the container may keep water or water-based liquid at a low temperature to reduce rate of carbonation outgassing or increase carbonation duration, after carbonation and seal is open. In an embodiment, the container may keep water or water-based liquid at a high temperature to increase rate of carbonation outgassing or decrease carbonation duration, after carbonation and seal is open. In an embodiment, the container may keep water or water-based liquid at a low temperature to increase water or water-based liquid capacity to absorb carbon dioxide as carbonic acid when carbonating and seal is closed. In an embodiment, the container may keep water or water-based liquid at a high temperature to decrease water or water-based liquid capacity to absorb carbon dioxide as carbonic acid when carbonating and seal is closed. In an embodiment, the container may keep water or water-based liquid at a temperature between about −18° C. to about 500° C. and any possible value between.

In an embodiment, the container may contain a wall. In an embodiment, the wall may comprise a wall structure with various characteristics such as number of walls, thickness of walls, insulation type, material type, shape, curvature, texture, nucleation sites, or other specifications. A wall may comprise a thickness between about 0.05 millimeters to about one inch and every possible value between.

In an embodiment, the container may have a single wall. The single wall may thinner, equal to, or thicker than that of a standard aluminum can. The single wall may be thinner, equal to, or thicker than that of a standard re-useable water bottle. The single wall may be thinner, equal to, or thicker than that of a standard keg.

In an embodiment, the container may have double walls where an inner wall is surrounded by an outer wall. The inner or outer wall may be thinner, equal to, or thicker than that of a standard reusable insulated aluminum or stainless steel water bottle. The inner or outer wall may thinner, equal to, or thicker than that of a standard aluminum can. The inner or outer wall may be thinner, equal to, or thicker than that of a standard re-useable water bottle. The inner or outer wall may be thinner, equal to, or thicker than that of a standard keg.

In an embodiment, the inner wall may be thinner, equal to, or thicker than outer wall. The outer wall may be thinner, equal to, or thicker than inner wall. The walls may be composed of the same or different materials.

In an embodiment, a wall may be curved. A wall may be concave or convex. A wall may terminate at the opening, lid, seal, or receptacle containing effervescent composition. Double walls may join into a single wall. A single wall may divide into double walls. Multiple walls may terminate or join at the top or bottom of the container or anywhere throughout.

In an embodiment, the distance between the inner wall and outer wall may differ throughout length of the container walls.

In an embodiment, the area between container inner walls may be configured to receive water or water based liquid or effervescent composition released from the receptacle for effervescent composition.

In an embodiment, the inner surface of the most inner wall adjacent to the water or water-based liquid may comprise nucleation sites. In an embodiment, the inner surface of the most inner wall adjacent to the water or water-based liquid may comprise one or more mechanisms that can affect the location of bubble nucleation sites or moderate motion of water or water based liquid during bubbling. The mechanism affecting nucleation sites may include a material, shape, texture, surface, or device that can affect the location of bubble nucleation sites or moderate motion of water or water-based liquid when carbon dioxide forms from carbonic acid. In an embodiment, a mechanism affecting nucleation may be located at the top third, bottom third, middle third, any location on the side, in multiple locations, evenly throughout, or any combination thereof. In an embodiment, the mechanism may be integral to the container or removable.

In an embodiment, the ACWEC comprises nucleation sites. Nucleation sites may also be referred to as bubble nucleation sites or a mechanism that affects the location of bubble nucleation sites. In an embodiment, the ACWEC may comprise a mechanism that affects the location and number of bubble nucleation sites. In an embodiment, the nucleation sites may affect, moderate, or contribute to motion of water or water-based liquid. In an embodiment, the nucleation sites or mechanisms that may affect the location or number of nucleation sites may restrict, inhibit, slow, cause, accelerate, or speed the motion of water or water-based liquid. The number of nucleation sites may range from 1 to 50 million and every possible value in this range. In an embodiment, the ACWEC may comprise many or few nucleation sites. A mechanism that affects the number of nucleation sites, location of bubble nucleation sites, or moderates motion of water or water-based liquid may increase, decrease, moderate, affect, or control the formation, size, motion, convective motion, rate, surface stability, or lifetime of carbon dioxide bubbles and the affects thereof.

In an embodiment, a nucleation site may create a small CO2 bubble that dissolves faster or slower than a larger bubble into water or water-based liquid to create carbonic acid carbonation. In an embodiment, a nucleation site may create a large CO2 bubble that dissolves faster or slower than a small bubble into water or water-based liquid to create carbonic acid carbonation. In an embodiment, a nucleation site may develop a large bubble that contains more CO2 gas than a small bubble or vice versa. In an embodiment, a nucleation site may develop a large bubble that may or may not create more pressure at a faster rate in the headspace than a small bubble or vice versa. In an aspect, many large bubbles may create more pressure in the ACWEC or headspace at a faster rate than many small bubbles.

In an embodiment, a nucleation site may be intentionally positioned at a preferential location or nucleated. In an aspect, a nucleation site me be a starting point for the formation of a CO2 bubble. In an aspect, a nucleation site may provide a cluster or gas or vapor embryo. In an aspect, bubble nucleation may be affected by temperature or supersaturation level of water or water-based liquid. In an embodiment, a bubble nucleus may grow if the temperature of the fluid at the distance from the wall equal to the bubble height is greater than the superheat requirement. In an embodiment, the nucleation site may be a mechanism that affects the location of bubble nucleation sites.

In a closed or sealed container, a mechanism that affects the location or number of bubble nucleation sites or moderates motion of water or water-based liquid may affect or control headspace pressure or control or affect the rate or ability of carbon dioxide gas to dissolve back into liquid as carbonic acid. The mechanism may prevent too much headspace pressure from occurring all at once. The mechanism may increase the rate of carbon dioxide gas dissolving into water or water-based liquid as carbonic acid thus increasing the rate of water or water-based liquid being carbonated. In an embodiment, a mechanism may comprise bubble nucleation sites closer to surface that may produce smaller bubbles. In an embodiment, a mechanism affecting nucleation or a nucleation site may inhibit, reduce, limit, cause, speed, or accelerate motion or convection motion of water or water-based liquid. In an embodiment, a nucleation site mechanism or nucleation site may inhibit, reduce, limit, cause, speed, or accelerate carbon dioxide gas dissolving into water or water-based liquid as carbonic acid.

In an open or unsealed container, a mechanism that affects the location or number of bubble nucleation sites or moderates the motion of water or water-based liquid may affect or control the rate of carbon dioxide outgassing, size or shape of bubbles, and amount of aerosols. This mechanism may extend the duration of effervescence or outgassing. This mechanism may manage or control foam amount or foam quality on the surface of the water or water-based liquid. The mechanism may impact emission of aroma or perception of flavor. The mechanism that affects the location or number of bubble nucleation sites or moderates motion of water or water-based liquid may also impact tingling sensation or mouth feel.

In an embodiment, the nucleation site may result in homogenous nucleation. In an embodiment, homogenous nucleation may occur if the water or water-based liquid is at high levels of supersaturation. In an embodiment, the nucleation site may result in heterogenous nucleation. In an embodiment, heterogenous nucleation may occur at surface cavities at lower levels of supersaturation. In an embodiment, the nucleation site may result in pseudo-classical nucleation. In an embodiment, the pseudo-classical nucleation may use pre-existing gas cavities that have radii smaller than the critical radius to lower the nucleation energy barrier. In an embodiment, the nucleation site may result in a non-classical nucleation. In an embodiment, a non-classical nucleation may occur at pre-existing gas cavities where the radii is larger than the critical radius, reducing the energy barrier to zero.

In an embodiment, a mechanism that affects the location or number of bubble nucleation sites may or may not comprise one or more of a texture, bump, ridge, rib, ring, platform, perforated platform, pocket, crevice, cavity, pit, peg, mesh, screen, matrix, grate, paddle, tube, funnel, tower, wall, ceiling, floor, blockage, indentation, protrusion, chamber, cage, or fracture. The mechanism affecting nucleation may be micro. The mechanism affecting nucleation may be etched. The mechanism affecting nucleation may be laser etched. The mechanism affecting nucleation may be a shape, angle, or curve of the container. The mechanism affecting nucleation may be a container wall or surface that is smooth, rough, concave, or convex. The mechanism affecting nucleation may be a textured surface. The textured surface comprise a type selected from parallel, across, crossed, multidirectional, concentric, radial, or non-directional.

In an embodiment, nucleation sites may create a constant or non-constant stream of bubbles that impact the characteristics of a bubble, and bubble or foam retention on the surface of water or water-based liquid. In an embodiment, nucleation sites may help release carbon dioxide gas. In an embodiment, nucleation sites may improve the aroma or perceived flavor of the water or water-based liquid. In an embodiment, nucleation sites may extend the duration of carbonation in water or water-based liquid when the ACWEC is open.

In an embodiment, the container may comprise one or more walls composed of materials or a mechanism to enhance or magnify contents or the visibility of an effervescence reaction, outgassing, bubbling, or foaming. The mechanism may be a configuration of walls or shape or curvature of one or more walls. In an embodiment, the container may comprise one or more walls composed of one or more bi-convex lenses to produce a magnified image. A bi-convex lens is one that is convex on both sides.

In an embodiment, the container may comprise one or more hinges. A hinge may be metal, plastic, acrylic, other polymer, or a combination thereof. A hinge may be surface mounted or integral. A hinge me be located on the exterior or interior of the container.

In an embodiment, the container may comprise male or female threads. Threads may be internal or external threads. Threads may be a coarse type with a large amount of space between threads or a fine type with a small amount of space between threads. Threads may contact a stopper to prevent over tightening. Threads may contact a stopper to prevent over overtightening on a seal or gasket.

In an embodiment, the container may comprise a mechanism to increase pressure inside the container or headspace. The mechanism may comprise a manual or automatic pump. The mechanism may be pumped by hand or finger. The mechanism may comprise an attachment for a manual or automatic pump. The mechanism be integral, removable, or may be a component to receive an attachment from another device or appliance.

In an embodiment, any metal component of the container may be coated, overmolded, sealed, or otherwise covered with silicone, plastic, polymer, rubber, or other substance. The coating, overmolding, sealant, or cover may improve function, feel, or aesthetic.

In an embodiment, the container may be in one, two, three or more pieces.

In an embodiment, the container may comprise a cartridge. A cartridge may attach to the top, side, or bottom of the container. A cartridge may contain threads. A cartridge may contain a seal. A cartridge may contain a gasket. A cartridge may seal to the container. A cartridge may include the receptacle for effervescent composition. A cartridge may be the lid. A cartridge may be a cap.

In an embodiment, the container may contain an indicator that indicates the level of carbonation, that the container is sufficiently carbonated, the level of pressure, or when pressure has been released. An indicator may comprise a signal, a light, a switch, a physical change or a chemical change.

In an embodiment, the container may connect to the internet, WIFI, or Bluetooth. The receptacle may comprise a wireless connection or a direct connection. The receptacle may transmit, send, or receive electronic information. The receptacle may contain a sensor or a switch. The receptacle may connect to other electronic devices such as a computer, mobile device, tablet, or network.

In an embodiment, the container may be an appliance or fit into an appliance. The container or appliance may decrease or increase the temperature of water or water-based liquid or supply hot or cold water or water-based liquid to the container. The container or appliance may produce or receive counter pressure during carbonation to prevent the seal from failing due to a sudden increase in pressure. The container or appliance may function to fill the container with water or water-based liquid to a precise headspace or volume of water or water-based liquid. The container or appliance may function to increase or decrease pressure in the headspace by pumping or releasing air or gas. The container or appliance may cap or seal.

In an embodiment, the container may be shaped. The container may be tall, narrow, short, wide, or balanced. In an embodiment, a tall and narrow container may be more prone to tipping over than a shorter and wider container. In an embodiment, the container may be a cylinder, oblique cylinder, hexagonal prism, or be conical.

In an embodiment, a cylindrical container may comprise a diameter of about one centimeter to about one meter and every possible value between. In embodiment, a cylindrical container may comprise a height of about 2.54 inches to about 2 meters and every possible value between. In an aspect where the container is not a cylinder, the equivalent volume ranges may apply. In an embodiment, the described cylindrical container volumes may be the volume capacity of the container for water or water-based liquid, regardless of shape.

In an embodiment, the container is durable. The container may comprise 18/8 stainless steel construction (304 stainless steel) or polypropylene plastic resin (5 #plastic).

In an embodiment, the container may be BPA free, food-grade, or toxin-free. A product that is BPA-free is one that does not use the organic compound Bisphenol A in its construction. In an embodiment, the container may comprise recycled materials or recycled plastic.

In an embodiment, the exterior surface of the container may be powder coated, coated, overmolded, sealed, painted, or otherwise covered. The exterior surface may include a textured finish for grip.

In an embodiment, the container may be lightweight or heavy-duty. In an embodiment, the container may weigh between about 3 grams to about 300 kilograms and every possible value between.

In an embodiment, the container may comprise one or more handles. A handle may attach to a hinge or swivel. A handle may be fixed to or otherwise integrated into the container.

In an embodiment, the container is portable or easy to use. The container may comprise a slim or trim design to have functionally smaller outer dimensions or smaller inner volume capacity. The container may comprise a wide design to have functionally larger outer dimensions or larger inner volume capacity. The container may have a wide or spacious design.

In an embodiment, the container may contain lines, indicators, hashes, or text to indicate volume of container or volume of water or water-based liquid contents. Indication of volume may be in fluid ounces, liters, milliliters, cups, quarts, or gallons.

In an embodiment, the container comprises a drink delivery device. The drink delivery device may comprise a tap, spout, drinking spout, dispenser, straw, opening, lip, spray head, nozzle, cap, or threaded cap. The nozzle may be flat-fan, flood, raindrop, hollow-cone, or full-cone.

In an embodiment, the container may be a squeeze or sports bottle. In an embodiment, the container may be collapsible, fold down, or roll up. A collapsible container may improve storage or transportation utility.

In an embodiment, the container may comprise an infuser. An infuser may be built in or removable. An infuser may add flavor or other ingredient to water or water-based liquid.

In an embodiment, the container may contain grips. The grips may be hand grips. In an embodiment, the container may be ergonomically shaped for a hand. In an embodiment, the container may comprise a handle, clip, or lip.

In an embodiment, the container may be bundled with other like containers. The bundle may function to stored or transported multiples of the container. The bundle may be a multiple of 2. The bundle may be a quantity of 2, 4, 6, 8, 12, 24, 48, 64, 80, 96, 120, 124, 150, 180, or any value between about 2 and about 150. The bundle device may comprise a box or plastic rings. The bundle may be a multipack.

In an embodiment, the container may be stackable with similar containers. In an embodiment, the container or any component of the ACWEC may be dishwasher safe.

In an embodiment, the container may comprise a color. The color may function to improve visibility, safety, or act as an identifier. The color may be a single color or a combination of colors. The color may be red, orange, yellow, green, blue, indigo, violet, pink, purple, turquoise, gold, lime, maroon, navy, coral, teal, brown, white, black, sky, berry, grey, straw, silver, or sapphire. The color may be any combination of cyan, magenta, yellow and black (CMYK) or any combination of red, green, and blue (RGB),

In an embodiment, the container may include a material or pad that provides refractive coloring. The material or pad may comprise a material with a differentiating refractive index (optical density) to change speed and direction of light to refract light.

In an embodiment, the container may comprise a material that changes color when in contact with water or water-based liquid. The material may be polydiacetylene polymer. The container may comprise a material that changes color depending on temperature. The material may be thermochromic plastic. The container may comprise a material that changes color depending on internal pressure. The internal pressure may indicate a level of carbonation. The material may be a mechanochromic plastic. The container may comprise a material that changes color depending on contents or PH of water or water-based liquid. The material may be chromogenic material.

In an embodiment, the container may comprise a material that glows in the dark or has a luminescent effect. The material may comprise a phosphorescent material, zinc sulfide, or europium and dysprosium doped strontium aluminate.

In an embodiment, the ACWEC comprises a receptacle for effervescent composition. In an embodiment, a receptacle for effervescent composition may deliver or release an effervescent composition. In an embodiment, a receptacle for effervescent composition may be a delivery device or vice versa. In an embodiment, the receptacle may be or contain a shelf, recess, basket, cage, seat, ridge, container, vessel, dish, cup, cap, basin, bowl, box, cylinder with either side open or closed, slip, slide, slider, sliding cover, spring, torsion spring, capsule, cartridge, holder, handles, cover, casing, pouch, frame, pocket, mold, slot, hole, space, aperture, plug, protrusion, kicker, crossbar, poker, plunger, prong, peg, pin, rod, blade, breaker, or other type of receptacle.

In an embodiment, the receptacle for effervescent composition may contain a bottom or floor surface, where the effervescent composition sits, that is not parallel with the water line or bottom of the container.

In an embodiment, the receptacle for effervescent composition may contain a spring. The spring may be a compression, extension, torsion, or constant force spring.

In another embodiment, the receptacle for effervescent composition may contain a magnet. The magnet may be coated with silicone, plastic, rubber, polymer, or other substance. The receptacle may contain magnetic metal containing iron, nickel, or cobalt. The receptacle may contain ferromagnetic materials such as iron or metals that contain iron such as steel.

In an embodiment, the receptacle may contain an expansion plug or a quick snap expansion plug.

In an aspect, any metal component may be coated or overmolded with silicone, plastic, rubber, polymer, or other substance. The coating or overmolding may improve function, feel, or aesthetic.

In an embodiment, the receptacle may be angular or have curvature. The receptacle shape may function to receive, aid in receiving, release, or aid in releasing the effervescent composition.

In an embodiment, the receptacle for effervescent composition may contain one or more hinges. A hinge may be metal, plastic, acrylic, other polymer, or other material. A hinge may be surface mounted or may be integral. A hinge may be located an exterior or interior surface of the receptacle.

In an embodiment, the receptacle for effervescent composition may contain male or female threads. The receptacle may contain internal threads or external threads. The receptacle may contain coarse threads with a large amount of space between threads or fine threads with a small amount of space between threads.

In an aspect, the receptacle may be locked or unlocked. In an embodiment, the receptacle may contain a stoppage part or device to prevent over extension of receptacle release.

In an embodiment, the receptacle or any component thereof may be composed of any polymer, plastic, silicon, rubber, any metal, aluminum, stainless steel, magnet, carbon steel, acrylic or any material that the lid or the container may be composted of. Any metal component of the receptacle may be coated, overmolded, or otherwise covered with silicone, plastic, rubber, polymer, or other substance. The coating or overholding may improve function, feel, or aesthetic. In an aspect, the receptacle may contain polymer integrated metal or a rubberized coating over metal.

In yet another embodiment, the receptacle containing effervescent composition may comprise a surface texture for grip, slip, or other utility.

In an embodiment, the receptacle containing effervescent composition may be adjustable to fit varying effervescent composition volumes. The receptacle may be an interchangeable part. An interchangeable receptacle may allow for the loading of receptacles with varying volume capacities of effervescent composition and therefor change the amount of effervescent composition being released into the water or water-based liquid. In another embodiment, the receptacle may be adapted or receive adapters to increase or decrease the receptacle volume capacity. In yet another embodiment, the receptacle may be flexible, pliable, stretchable, contain springs, or allow for movement of receptacle walls to increase or decrease the height, width, depth, or volume capacity of the receptacle. In an embodiment, the receptacle for effervescent composition may apply back pressure on the effervescent composition in order to keep effervescent compositions of varying depths in place or flush with receptacle. In an aspect, the receptacle may allow for varying volumes of effervescent composition and therefore varying amounts of effervescent composition may be added to the water or water-based liquid, a mechanism that may be used to achieve a desired carbonation level of the water or water-based liquid.

In an embodiment, the receptacle for effervescent composition as a whole, or any component of the receptacle, may click, snap, latch, fix, lock, or otherwise attach into place.

In an embodiment, the receptacle for effervescent composition may contain a seal. The seal may be hermetically sealed or create a hermetic seal. The seal may comprise a gasket.

In an embodiment, the receptacle for effervescent composition may be or receive a pod, casing, coating, cartridge, or other primary packaging with effervescent composition contained within. The pod, casing, coating, cartridge, or other primary packaging may comprise aluminum, plastic, paper or a combination thereof. The pod, casing, coating, or cartridge maybe reusable or disposable. The pod, casing, coating, or cartridge may be hermetically sealed or create a hermetic seal. In an embodiment, the receptacle for effervescent composition may be a separate part from lid or container. The receptacle may function to hold the effervescent composition and make a seal. The receptacle may be inserted between the lid and the container. The seal or hermetic seal of the receptacle may be located or created between the lid and container sealing the lid and container together. The receptacle or seal may span and seal the opening.

In another embodiment, the receptacle for effervescent composition maybe be single-use or reusable. In an embodiment, the lid may be preloaded with the receptacle containing effervescent composition. The preloaded receptacle containing effervescent composition may be hermetically sealed, hermetically sealed within the lid, or create a hermetic seal with the lid. In an embodiment, the receptacle for effervescent composition may be disposable or recyclable.

In yet another embodiment, the receptacle for effervescent composition may be located on the top third, bottom third, middle third, interior, exterior, or any side of the lid or integrated into the lid in any location. In another embodiment, the receptacle for effervescent composition may be located on the top third, bottom third, middle third, interior, exterior, or any side of the container or integrated into the container in any location.

In an embodiment, the receptacle for effervescent composition be or may contain the volume capacity dimensions of a cuboid, a cylinder, or other three dimensional shape. In an embodiment, the receptacle or volume capacity of the receptacle may be cuboid with dimensions ranging from about 1 millimeter to about 30 centimeters in width by about 1 millimeter to about 30 centimeters in height by about 1 millimeter to about 30 centimeters in depth. In an embodiment, the receptacle or volume capacity of the receptacle may be cylindrical with dimensions ranging from about 1 millimeter to about 34 centimeters in diameter to about 1 millimeter to about 240 centimeters in height. In both cuboid and cylinder aspects, the dimension may be any possible value in the ranges provided. In an embodiment where the receptacle for effervescent composition or receptacle for effervescent composition volume capacity is not a cuboid or cylinder, the volume capacity may be substantially equal to any value in the ranges provided for the cuboid or cylinder.

In an embodiment, the receptacle for effervescent composition may contain a volume capacity equivalent to the amounts or volumes of the disclosed effervescent composition.

In an embodiment, the minimum volume capacity of the receptacle for effervescent composition may comprise about 0.03 cubic centimeters per fluid ounce volume capacity for water or water-based liquid. In another embodiment, the minimum volume capacity of the receptacle for effervescent composition may comprise about 0.0003 cubic centimeters per fluid ounce volume capacity for water or water-based liquid to about 3 cubic centimeters per fluid ounce volume capacity for water or water-based liquid.

In an embodiment, the ratio of the volume capacity of the receptacle for effervescent composition to the volume capacity of the container for water or water-based liquid must be greater than about 1:986. In another embodiment, the ratio of the volume capacity of the receptacle for effervescent composition to the volume capacity of the container for water or water-based liquid must be greater than about 1:9860. In another embodiment, the ratio of the volume capacity of the receptacle for effervescent composition to the volume capacity of the container for water or water-based liquid must be greater than about 1:98. Any ratio between these values may apply as the minimum volume capacity of the receptacle for effervescent composition to the volume capacity of the container for water or water-based liquid.

In an embodiment, the receptacle may contain electrical components. The receptacle may contain two or more conductive pieces or contacts. Conductive pieces may be metal. The receptacle may contain a circuit or external circuit. The receptacle may contain a power source. The receptacle may contain a battery. The receptacle may contain a conductor. The receptacle may contain cable or wire. The receptacle may contain a load that has resistance. The receptacle may contain a bulb, heating element, or a motor.

In an embodiment, the receptacle may connect to the internet, WIFI, or Bluetooth. The receptacle may comprise a wireless connection or a direct connection. The receptacle may transmit, send, or receive electronic information. The receptacle may contain a sensor or a switch. The receptacle may connect to other electronic devices such as a computer, mobile device, tablet, or network.

In an embodiment, the ACWEC comprises a mechanism or action to deliver or release an effervescent composition from a receptacle. In an embodiment, the mechanism or action to release effervescent composition may be a delivery device. In another embodiment, the delivery device may be a mechanism or action to release an effervescent composition. In an embodiment, the delivery device may be the receptacle for effervescent composition. In one embodiment, the delivery device for the effervescent composition may be the same as the receptacle. In other embodiments, the delivery device and the receptacle may be different. In an embodiment, the mechanism or action may release an effervescent composition into the lid, container, headspace, water, or water-based liquid.

In an embodiment, the mechanism or action to release effervescent composition from receptacle may be closing the lid, closing a cap, or closing another component of the lid.

In an embodiment, the mechanism or action may comprise an activator such as a trigger, button, lever, cam lever, switch, snap, twist, tighten, or tip. The mechanism or action may comprise rotating or tipping the ACWEC on its side, upside down, or right side up to release the effervescent composition from the receptacle.

In an embodiment, the mechanism or action to release effervescent composition from the receptacle may involve the effervescent composition being bumped off, pushed off, slid off, swept off, dumped off, dispensed, rotated off, moved off, popped out, tipped out of, knocked off, poked through, screwed through, or pushed through the receptacle releasing an effervescent composition. In other embodiments, the mechanism or action may cause the effervescent composition to be snaped, broken, or cut and allowed to pass through an opening. In an embodiment, the mechanism or action may be loading in, on, or through a component of the ACWEC. In other embodiments, the mechanism or action may be a squeeze, pinch, pull apart, or separation. In an aspect, the mechanism or action may cause the effervescent composition to fall out of the receptacle opening or from the receptacle opening.

In an embodiment, the mechanism or action to release effervescent composition from the receptacle may be punching it, out or otherwise extracting, the effervescent composition from a pod, casing, cartridge, or other primary packaging containing the effervescent composition.

In an embodiment, the mechanism or action may be utilizing a magnet or magnetism to release the effervescent composition. In another aspect, the mechanism or action may be an electrical signal. The effervescent composition may fall by gravity after the receptacle is released from magnetism or electrical signal.

In an embodiment, the mechanism or action may be a spring or torsion spring that may push or tip the receptacle to release the effervescent composition. In yet another embodiment, the mechanism or action may be closing the lid or a cap on which the receptacle is attached, causing the receptable to dump out the effervescent composition using gravity.

In an embodiment, the ACWEC comprises a seal. The seal may be sealed before the effervescent composition is immersed in water or water-based liquid. The seal may be a hermetic seal or create a hermetic seal. The seal may be airtight. The seal may be open, partially open, or closed. The seal may release pressure. The seal may comprise a maximum pressure capacity or rating of between about 5 PSI to about 300 PSI, about 10 PSI to about 150 PSI, about 40 PSI to about 100 PSI, or about 30 PSI to about 50 PSI. Pressure inside the ACWEC may increase as temperature increases and the pressure may decrease as temperature decreases.

The ACWEC may comprise one, two, three, four, five, or more seals up to twenty five. The ACWEC may comprise more than twenty five seals.

In an embodiment, the seal may be sealed as a result of pressure from the effervescence reaction. The seal strength may increase as pressure inside the ACWEC increases.

In an embodiment, the seal may be sealed with pressure from tightening threads, a latch, a clamp, a clip, a buckle, a spring, a plunger, an expansion plug, a quick snap, or pressure from any other mechanism described in the ACWEC. The seal may receive pressure from one, two, three or more caps, latches, clamps, buckles, threaded components, sliding covers or other mechanisms. The seal may be seated, push on a tapered edge, or push on a shoulder for improved seal strength. The seat, tapered edge, or shoulder may be part of the lid, cap, container, receptacle for effervescent composition, or other component of the ACWEC.

In an embodiment, the seal may be protected by a stopper that functions to prevent overtightening on a seal or gasket.

In an embodiment, the seal may comprise a gasket. In an embodiment, the seal may comprise a gasket located inside of a threaded lid or cap which may hold or release pressure. In an embodiment, a pressure release mechanism may be a gasket. In an embodiment, a gasket may be rubber, EPDM rubber, silicone, neoprene, neoprene sponge, nitrile (NBR, BUNA-N), cork, felt, compressed non-asbestos, fiberglass, graphite, teflon, polytetrafluoroethylene (PTFE), plastic, polychlorotrifluoroethylene, plastic polymer or any other polymer.

In an embodiment, the seal may fit snuggly in a seat designed to house a seal or gasket. The seal or gasket maybe located near the top or bottom of a thread, or anywhere else along a thread. The seal or gasket may be held in place by a lip overhang located adjacent to the outer or inner circumference of the gasket. The lip material may be plastic, aluminum, stainless steel, other metal, rubber, silicone, or other polymer.

In an embodiment, the seal may comprise a plunger or cam-lock plunger. The plunger may be rubber, EPDM rubber, silicone, neoprene, neoprene sponge, nitrile (NBR, BUNA-N), cork, felt, compressed non-asbestos, fiberglass, graphite, teflon, polytetrafluoroethylene (PTFE), plastic, polychlorotrifluoroethylene, plastic polymer or any other polymer.

In an embodiment, the outer diameter, inner diameter, width or thickness of the seal or gasket may vary between about one micrometer to about 50 centimeters and any value between.

In an embodiment, the ACWEC comprises a mechanism to release pressure. The mechanism to release pressure may be a pressure release device. The pressure release device may be a mechanism to release pressure. The mechanism to release pressure may be automatic or manual. The mechanism to release pressure may be a valve. The valve may be a pressure relief valve or a pressure release valve. The pressure relief valve or pressure release valve may be spring loaded, balanced spring loaded, or pilot operated. The valve may be a pressure release valve, safety valve, safety relief valve, relief valve, power-actuated pressure relief valve, temperature-actuated pressure relief valve, or vacuum relief valve. The valve may be an acting-type pressure relief valve, piston-type pressure relief valve, diaphragm-type pressure relief valve. Any component of the ACWEC may contain a piston or diaphragm. The valve may provide other functions aside from releasing pressure.

In an embodiment, a valve may be a ASME I valve, ASME VIII valve, low lift safety valve, full lift safety valve, full bore safety valve, conventional safety relief valve, balanced safety relief valve, pilot operated pressure relief valve, power-actuated safety relief valve, DIN 3320 standard valve, standard safety valve, full lift (Vollhub) safety valve, direct loaded safety valve, proportional safety valve, diaphragm safety valve, bellows safety valve, controlled safety valve, EN ISO 4126 valve, safety valve, direct loaded safety valve, assisted safety valve, supplementary loaded safety valve, or pilot operated safety valve. The mechanism to release pressure may contain any component, function or a combination of components or functions from the disclosed valve types.

In an embodiment, the mechanism to release pressure may comprise any metal, bronze, cast iron, SG iron, cast steel, austenitic stainless steel, stainless steel, carbon steel, tungsten steel, viton, nitrile, EPDM, steel alloy, music wire, chrome silicon, oil-tempered wire, metal, plastic, rubber, silicone, or any other polymer.

In an embodiment, the mechanism to release pressure may comprise a spring. The mechanism to release pressure may comprise threads, a vent, a gasket, or a diaphragm. The mechanism to release pressure may be, include, or be activated with a button, switch, slider, push, pull, turn, twist, thread, screw, spring, seal, lever, cam lever, or electrical signal.

In an embodiment, the mechanism to release pressure may contain a sensor or switch. The mechanism to release pressure may be activated from an electronic transmitted signal from another electronic device such as a computer, mobile device, tablet, or network. The signal may be transmitted through the internet, Wi-Fi, Bluetooth, a wireless connection, or a direct connection.

In an embodiment, the mechanism to release pressure may be a safety function. The mechanism to release pressure may release pressure before the lid or a cap is opened for use or consumption. The mechanism to release pressure may release pressure when the pressure reaches a seal maximum pressure capacity. The mechanism to release pressure may release pressure before the pressure reaches a seal maximum pressure capacity. The mechanism to release pressure may control the pressure, control the pressure release, provide a slow release, or provide a quick release.

In an embodiment, the pressure may be released when pressure reaches 5 PSI, 10 PSI, 15 PSI, 20 PSI, 25 PSI, 30 PSI, 35 PSI, 40 PSI, 45 PSI, 50 PSI, 55 PSI, 60 PSI, 65 PSI, 70 PSI, 75 PSI, 80 PSI, 85 PSI, 90 PSI, 95 PSI, 100 PSI, 105 PSI, 110 PSI, 115 PSI, 120 PSI, 125 PSI, 130 PSI, 135 PSI, 140 PSI, 145 PSI, 150 PSI, 155 PSI, 160 PSI, 165 PSI, 170 PSI, 175 PSI, 180 PSI, 185 PSI, 190 PSI, 195 PSI, or 200 PSI. In an embodiment, the pressure may be released when the pressures reach between about 5 PSI to about 200 PSI or at any value in between. In an aspect, the mechanism to release pressure may release pressure when pressure is greater than 200 PSI.

In an embodiment, the mechanism to release pressure may contain an indicator that indicates pressure level, when container is sufficiently carbonated, or when pressure has been released and the ACWEC is safe to open.

In an embodiment, the ACWEC comprises an opening. The opening may be opened, closed, tightened, untightened, secured, unsecured, partially open, partially closed, sealed, or unsealed. There may be one, two, three, four, five or more openings. Each opening may serve one or more functions.

In an aspect, an opening may be used to insert or load an effervescent composition into the ACWEC. An opening may be used for drinking. An opening may have a specialized design to make consumption easier or to reduce or eliminate spills. An opening may be partially or fully recessed or raised. An opening may be used to release pressure. An opening may be sized for drinking. An opening may be sized for drinking, consumption, or use by an adult, child, infant, animal, or other organism.

In an embodiment, an opening may be sized to reduce CO2 outgassing to increase duration of effervescence. An opening may be used to consume water or water-based liquid contents. An opening may be used to pour water or water-based liquid contents. An opening may be used to clean the lid, container, or any other component of the ACWEC. An opening may be used to access, withdraw, distribute or otherwise use water or water-based liquid contents.

In an embodiment, an opening may result from the removal of the lid from the container. An opening may be located on the lid, centered on lid, offset from lid center, or on the side of the lid. The lid, the container, the receptacle for effervescent composition, or the mechanism to release pressure may contain one or more openings.

In an embodiment, a circular opening may comprise a diameter of about one nanometer to about one meter and every possible value between. If the opening is not a circle, the opening may have an area equivalent to that of the circular opening described.

In an embodiment, the ACWEC comprises a volume for headspace. The volume for headspace may be proportional to an amount of effervescent composition, or volume capacity of a receptacle for effervescent composition, to exact sufficient pressure to force CO2 into water or water-based liquid as carbonic acid. The volume of headspace may be proportional to a volume of water or water-based liquid in the ACWEC, or a container volume capacity for water or water-based liquid, to exact sufficient pressure to force CO2 into water or water-based liquid as carbonic acid.

In an embodiment, the volume or volume capacity for headspace may be between about 1 cubic centimeter to about 0.25 cubic meters including every possible value in between. In an embodiment, the headspace may be less than 1 cubic centimeter or more than 0.25 cubic meters.

In another aspect, the headspace may comprise a mechanism to increase or decrease the volume of headspace. A component of the lid, container, or receptacle for effervescent composition may be moved into the headspace to increase pressure or moved out to decrease pressure in the headspace. There may be a separate or integral mechanism, or attachment from other device, to increase or decrease pressure in the headspace. Characteristics and functions of the lid, the container, the receptacle for effervescent composition or volume thereof, a seal, the mechanism to release pressure, an opening, water or water-based liquid or a volume thereof, may affect the volume capacity for headspace and function of the headspace on the ACWEC.

In an embodiment, the ACWEC comprises a volume for water or water-based liquid. In an embodiment, the volume, capacity, or volume capacity for water or water-based liquid may be the same as the volume capacity of the container for water or water-based liquid. In an embodiment, the volume capacity for water or water-based liquid may container H20 water for a reaction with carbonate or bicarbonate and acid when mixed.

In another embodiment, the volume of water or water-based liquid or capacity for water or water-based liquid may comprise about 1.5 fl. oz. to about 25,600 fl. oz., about 4 fl. oz to about 6,400 fl. oz., about 8 fl. oz. to about 1,984 fl. oz., about 12 oz. to about 640 fl. oz., about 16 fl. oz. to about 120 fl. oz., about 18 fl. oz. to about 80 fl. oz., about 22 fl. oz. to about 64 fl. oz., about 21 fl. oz. to about 40 fl. oz., about 24 fl. oz. to about 32 fl. oz., or any possible value between. In another embodiment, the volume capacity for water or water-based liquid may be less than 1.5 fl. oz. or more than 25,600 fl. oz.

In an embodiment, the volume capacity for water or water-based liquid be indicated by a fill to line.

In an embodiment, the volume capacity for water or water-based liquid may provide, contain, compliment, be proportional to, maintain a ratio with, enhance, or diminish any function of the container, lid, headspace, volume capacity for headspace, receptable for effervescent composition, volume capacity of receptacle for effervescent composition, a mechanism or action to release effervescent composition from receptacle, a seal, a mechanism to release pressure, or an opening.

The foregoing description of the preferred embodiments of the present invention has been presented for purposes of illustration and description. It is not intended to be exhaustive or to limit the invention to the precise form or to the exemplary embodiments disclosed. Obviously, many modifications and variations will be apparent to practitioners skilled in this art. Similarly, any process steps described might be interchangeable with other steps in order to achieve the same result. The embodiments were chosen and described in order to best explain the principles of the invention and its best mode practical application, thereby to enable others skilled in the art to understand the invention for various embodiments and with various modifications as are suited to the particular use or implementation contemplated. It is intended that the scope of the invention be defined by the claims appended hereto and their equivalents. Reference to an element in the singular is not intended to mean “one and only one” unless explicitly so stated, but rather means “one or more.” Moreover, no element, component, nor method step in the present disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . ”

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way. It is also to be understood that the steps and processes recited in the claims need not be performed in the order presented.

1. An apparatus, comprising:
a lid coupled to a container wherein the ratio of a volume capacity of a receptacle for effervescent composition to a volume capacity of the container for water or water-based liquid is greater than 1:986;
wherein the container includes nucleation sites that contribute to motion of water or water-based liquid while effervescing;
a receptacle being one of coupled to the lid or the container;
a delivery device to deliver an amount of effervescent composition from the receptacle to the water or water-based liquid when the lid and container are coupled to form a seal, wherein the seal holds pressure when the water or water-based liquid is carbonated;
a pressure release mechanism coupled to one of the container or lid to release pressure when the container and lid are sealed and when the pressure increases above a seal strength and before the apparatus containing carbonated water or water-based liquid is open; and
a headspace between an inside portion of the lid and a height of the water or water-based liquid with a volume capacity for gas to provide sufficient pressure when sealed to force carbon dioxide gas into the water or water-based liquid contents as carbonic acid;
wherein the apparatus is BPA free, food-grade, and toxin-free.

2. The apparatus of claim 1 wherein the effervescent composition comprises an acid and at least one selected from the group of a carbonate, bicarbonate, and combinations thereof that produce carbon dioxide gas when mixed with water or water-based liquid.

3. The apparatus of claim 1, wherein the lid is coupled to one of a reusable container and a single-use container.

4. The apparatus of claim 1 wherein the container further comprises one of a wall structure and a material to retain a low temperature of water or water-based liquid.

5. The apparatus of claim 1, wherein the seal is one of an airtight gasket and a hermetic gasket.

6. The apparatus of claim 1, wherein the pressure release mechanism is one of automatic and manual.

7. The apparatus of claim 1, wherein one of the lid and the container include markings for instructions of use.

8. The apparatus of claim 1 further comprising a fill to line for water or water-based ingredients.

9. The apparatus of claim 1 further comprising a drink delivery device.

10. The apparatus of claim 9, wherein the drink delivery device is one of a spout, straw, opening, and lip.

11. A method for carbonating water or water-based liquid, comprising:
delivering an amount of effervescent composition from a receptacle to a water or water-based liquid when a lid and container are coupled to form a seal, wherein the seal holds pressure inside the apparatus when the water or water-based liquid is carbonated and wherein the ratio of a volume capacity of the receptacle for effervescent composition to a volume capacity of the container for water or water-based liquid is greater than 1:986 and wherein the container includes nucleation sites that contribute to motion of water or water-based liquid while effervescing;
releasing pressure via a pressure release mechanism when the container and lid are sealed and when the pressure increases above a seal strength and before the apparatus containing carbonated water or water-based liquid is open; and
providing a headspace between an inside portion of the lid and a height of the water or water-based liquid with a volume capacity for gas to provide sufficient pressure when sealed to force carbon dioxide gas into the water or water-based liquid contents as carbonic acid.

12. The method of claim 11, wherein the effervescent composition comprises an acid and at least one selected from the group of a carbonate, bicarbonate, and combinations thereof that produce carbon dioxide gas when mixed with water or water-based liquid.

13. The method of claim 11 coupling the lid to one of a reusable container and a single-use container.

14. The method of claim 11, wherein the container further comprises one of a wall structure and a material to retain a low temperature of water or water-based liquid.

15. The method of claim 11, wherein the seal is one of an airtight gasket and a hermetic gasket.

16. The method of claim 11, wherein the pressure release mechanism is one of automatic and manual.

17. The method of claim 11, wherein one of the lid and the container include markings for instructions of use.

18. The method of claim 11 further comprising providing a fill to line for water or water-based ingredients.

19. The method of claim 11 further comprising providing a drink delivery device.

20. The method of claim 19, wherein the drink delivery device is one of a spout, straw, opening, and lip.
